(19) United States
(12) Patent Application Publication
(10) Pub. No.: US 2024/0306248 A1
(43) Pub. Date: Sep. 12, 2024

(54) MANAGING AN EARLY DATA COMMUNICATION CONFIGURATION

(71) Applicant: GOOGLE LLC, Mountain View, CA (US)

(72) Inventor: Chih-Hsiang Wu, Taoyuan City (TW)

(21) Appl. No.: 18/579,861

(22) PCT Filed: Jul. 13, 2022
(86) PCT No.: PCT/US2022/036948

§ 371 Date: Jan. 16, 2024

Related U.S. Application Data
(60) Provisional application No. 63/222,807, filed on Jul. 16, 2021.

(51) Int. Cl. H04W 76/30; H04W 76/27; H04W 88/08

(52) U.S. Cl. CPC H04W 76/30; H04W 76/27; H04W 88/085

(57) ABSTRACT

A central unit (CU) of a distributed base station, the distributed base station including the CU and a distributed unit (DU), can implement a method for managing early data communication with a user equipment (UE). The method may include: determining (2202) whether the DU supports early data communication with a UE; determining (2204) whether to include a configuration for performing early data communication in a message to the UE based at least in part on whether the DU supports early data communication; and transmitting (2206) the message to the UE.

### FIELD OF THE DISCLOSURE

This disclosure relates generally to wireless communications and, more particularly, to communication of uplink and/or downlink data at a user equipment (UE) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state due to Radio Access Network (RAN)-level base station coordination and RAN-paging procedures. In some cases, the UE in the RRC_IDLE or RRC_INACTIVE state has only one, relatively small packet to transmit. In these cases, the UE in the RRC_IDLE or RRC_INACTIVE state can perform an early data transmission without transitioning to the RRC_CONNECTED state, e.g., by using techniques as specified in section 7.3a-7.3d in 3GPP specification 36.300 v16.4.0.

However, implementing data communication techniques while the UE is in an inactive state (e.g., RRC_INACTIVE) or an idle state (e.g., RRC_IDLE), i.e., early data communication, presents several challenges. In particular, a 5G NR radio access network (i.e., an NG-RAN) may include distributed base stations, where each distributed base station includes a central unit (CU) and at least one distributed unit (DU). To perform early data transmission techniques, the CU and DU implement their own specific functions (e.g., functions supporting subsequent early data communication, configured grant (CG) early data communication, etc.). In some deployment scenarios, the CU is not aware whether the DU supports these specific functions. As a result, the CU cannot determine how to configure early data communication with the UE.

### SUMMARY

Network nodes of a radio access network (RAN) and/or a user equipment (UE) can use the techniques of this disclosure to manage early data communication. As used in this disclosure, early data communication can refer to early data transmission (EDT) from the perspective of the network (i.e., EDT in the downlink direction), or EDT from the perspective of the UE (i.e., EDT in the uplink direction). Accordingly, this disclosure interchangeably uses the acronym EDT to refer to UL EDT or DL EDT (i.e., early data communication), unless otherwise specified.

A central unit of a distributed base station, for example, can determine whether a distributed unit (DU) of the distributed base station supports early data communication based on capability information pertaining to the DU. The CU may receive the capability information from the DU, such as in a DU-to-CU message. The CU can then determine whether to include a configuration for performing early data communication in a message to the UE based on whether the DU supports early data communication. If the DU supports early data communication, then the CU may include the configuration in the message before transmitting the message to the UE. Otherwise, the CU can exclude such a configuration from the message. The message may be a message instructing the UE to transition to an inactive state associated with a protocol for controlling radio resources (e.g., an RRCRelease message).

Additionally, the CU can determine, based on the capability information, whether the DU supports other functions related to early data communication, such as subsequent early data communication (i.e., communicating more than one data packet in a single early data communication session), utilizing configured grants for early data communication, and communicating repetitions or retransmissions during early data communication. Based on whether the DU supports such functions, the CU can determine whether to include parameters enabling the UE to perform the functions in the configuration.

Generally speaking, the capability information pertaining to the DU may indicate other functionalities in addition to, or instead of, early data communication functions. For example, the capability information may indicate whether the DU supports functions related to multicast broadcast services (MBS), mobility, and/or enhanced paging.

One example embodiment of these techniques is a method implemented in a CU of a distributed base station, the distributed base station including the CU and a DU, for managing early data communication with a UE. The method can be executed by processing hardware and includes: determining whether the DU supports early data communication with a UE; determining whether to include a configuration for performing early data communication in a message to the UE based at least in part on whether the DU supports early data communication; and transmitting the message to the UE.

Another example embodiment of these techniques is a method implemented in a DU of a distributed base station, the distributed base station including the DU and a CU, for managing early data communication with a UE. The method can be executed by processing hardware and includes: providing, to a CU, an indication that the DU supports early data communication; receiving, from the CU, a message enabling the UE to perform early data communication; transmitting the message to the UE; and performing early data communication with the UE when the UE operates in an inactive state associated with a protocol for controlling radio resources.

A further example of these techniques is a method implemented in a CU of a distributed base station of a RAN, the distributed base station including the CU and a DU, for managing communications with a UE. The method can be executed by processing hardware and includes: receiving from the DU, first capability information indicating capabilities of the DU; receiving second capability information indicating capabilities of the UE; determining, based on the first capability information and the second capability information, whether the UE and the DU both support a particular functionality related to communications between the UE and the RAN; and based on the determining, configuring the UE with respect to the particular functionality.

Another example embodiment of these techniques is a network node of a distributed base station including processing hardware and configured to implement any one of the methods above.

Yet another example embodiment of these techniques is a method implemented in a UE for communicating with a base station. The method includes receiving, from the base station, a configuration for performing early data communication; transitioning to an inactive state associated with a protocol for controlling radio resources; transmitting a first data packet to the base station; determining whether the configuration enables the UE to transmit the first data packet and a second data packet to the base station during a session of the early data communication; and based on the determining, transmitting the second data packet to the base station.

Another example embodiment of these techniques is a UE including processing hardware and configured to implement the above method.

### BRIEF DESCRIPTION OF THE DRAWINGS

FIG. 1A is a block diagram of an example wireless communication system in which a user equipment (UE) and/or a base station can implement the techniques of this disclosure for managing early data communication between the UE and a radio access network (RAN);

FIG. 1B is a block diagram of an example base station including a central unit (CU) and a distributed unit (DU) that can operate in the system of FIG. 1A;

FIG. 2A is a block diagram of an example protocol stack according to which the UE of FIG. 1A can communicate with base stations;

FIG. 2B is a block diagram of an example protocol stack according to which the UE of FIG. 1A can communicate with a DU and a CU of a base station;

FIG. 3 is an example message sequence in which a CU determines whether to transmit an early data transmission (EDT) configuration to a UE based on capabilities of a DU;

FIG. 4A is an example message sequence in which a CU determines whether to transmit a subsequent EDT configuration to a UE based on capabilities of a DU, and the UE determines, after performing initial EDT, whether to perform subsequent EDT based on whether the UE receives a subsequent EDT configuration;

FIG. 4B is an example message sequence similar to the message sequence of FIG. 4A, but where the UE determines, before performing initial EDT, whether to perform subsequent EDT;

FIG. 4C is an example message sequence similar to the message sequence of FIG. 4B, but where the UE determines whether to perform subsequent EDT based on whether the UE meets criteria included in a subsequent EDT configuration;

FIG. 5 is an example message sequence in which a CU determines whether to transmit a configured grant (CG) configuration for EDT to a UE based on capabilities of a DU;

FIG. 6 is a flow diagram of an example method for performing early data communication with a UE, which can be implemented by a DU;

FIG. 7 is a flow diagram of an example method for performing subsequent early data communication with a UE, which can be implemented by a DU;

FIG. 8 is a flow diagram of an example method for performing early data communication with a UE using a CG configuration, which can be implemented by a DU;

FIG. 9 is a flow diagram of an example method for determining whether to send an EDT configuration to a UE, which can be implemented by a CU;

FIG. 10 is a flow diagram of an example method for determining whether to enable a UE to use an EDT-related function, which can be implemented by a CU;

FIG. 11 is a flow diagram of an example method for determining whether to send an EDT configuration to a UE, which can be implemented by a RAN;

FIG. 12 is a flow diagram of an example method for determining whether to enable a UE to use an EDT-related function, which can be implemented by a RAN;

FIGS. 13A-13B are flow diagrams of example methods for configuring a UE to perform EDT and EDT-related functions, which can be implemented by a RAN;

FIG. 14A is a flow diagram of an example method for configuring early data communication based on whether a UE supports subsequent early data communication, which can be implemented by a CU;

FIG. 14B is a flow diagram of an example method for configuring early data communication based on whether a RAN supports subsequent early data communication, which can be implemented by a CU;

FIG. 14C is a flow diagram of an example method for configuring early data communication based on whether a UE has subsequent data to transmit, which can be implemented by a CU;

FIG. 14D is a flow diagram of an example method for configuring early data communication based on whether a CU has data to transmit to the UE, which can be implemented by the CU;

FIG. 14E is a flow diagram of an example method for configuring early data communication based on whether the UE supports early data communication, which can be implemented by a CU;

FIG. 14F is a flow diagram of an example method for configuring early data communication based on whether a RAN supports subsequent early data communication, which can be implemented by a CU;

FIG. 14G is a flow diagram of an example method for configuring early data communication based on whether a UE has subsequent data to transmit, which can be implemented by a CU;

FIG. 14H is a flow diagram of an example method for configuring early data communication based on whether a CU has data to transmit to the UE, which can be implemented by the CU;

FIG. 15 is a flow diagram of an example method for determining whether to perform subsequent early data communication, which can be implemented by a UE;

FIGS. 16A-16B are flow diagrams of example methods for determining whether to use early data communication to transmit multiple data packets to a RAN, which can be implemented by a UE;

FIG. 17A is a flow diagram for determining when to send an RRC release message to a UE after performing early data communication, based on whether the UE supports subsequent early data communication, which can be implemented by a RAN;

FIG. 17B is a flow diagram for determining when to send an RRC release message to a UE after performing early data communication, based on whether the RAN supports subsequent early data communication, which can be implemented by a RAN;

FIG. 17C is a flow diagram for determining when to send an RRC release message to a UE after communicating data with the UE, based on whether the UE is in an inactive or a connected state, which can be implemented by a RAN;

FIG. 18 is a flow diagram of an example method for informing a CU of DU capabilities related to a function and using the function to communication with a UE, which can be implemented by a DU; and

FIG. 19 is a flow diagram of an example method for determining whether to enable a UE to perform a function based on whether the DU supports the function, which can be implemented by a CU;

FIGS. 20-21 are flow diagrams for enabling a DU and a UE to perform a function based on whether the DU and the UE support the function, which can be implemented by a CU;

FIG. 22 is a flow diagram of an example method for managing early data communication with a UE, which can be implemented by a CU;

FIG. 23 is a flow diagram of an example method for managing early data communication with a UE, which can be implemented by a DU;

FIG. 24 is a flow diagram of an example method for communicating data with a base station, which can be implemented by a UE; and

FIG. 25 is a flow diagram of an example method for managing communications with a UE, which can be implemented by a CU.

### DETAILED DESCRIPTION OF THE DRAWINGS

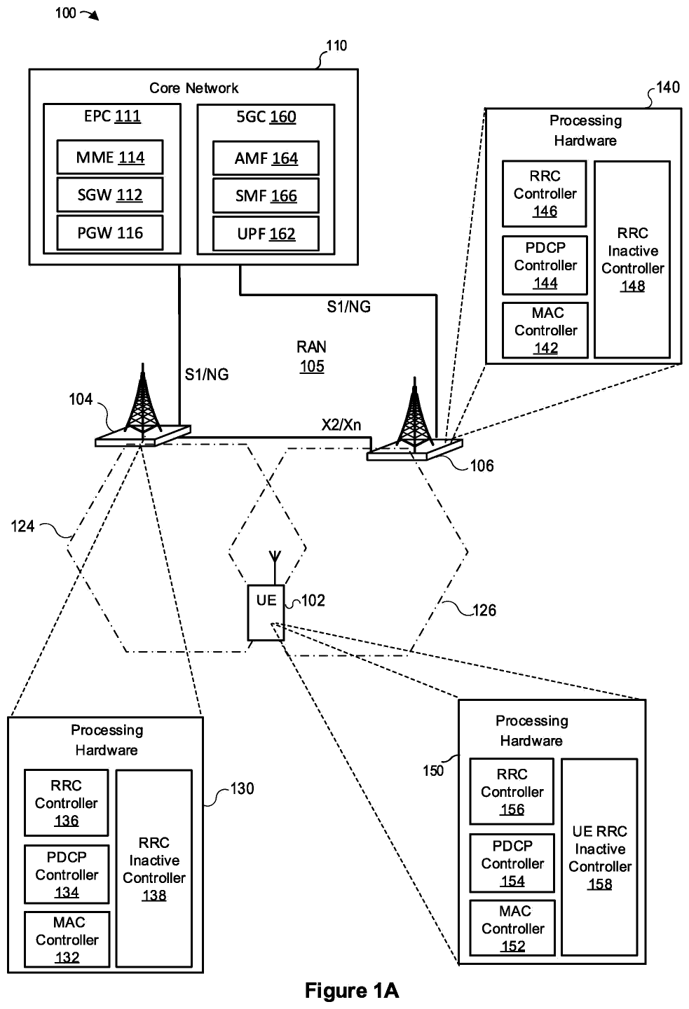

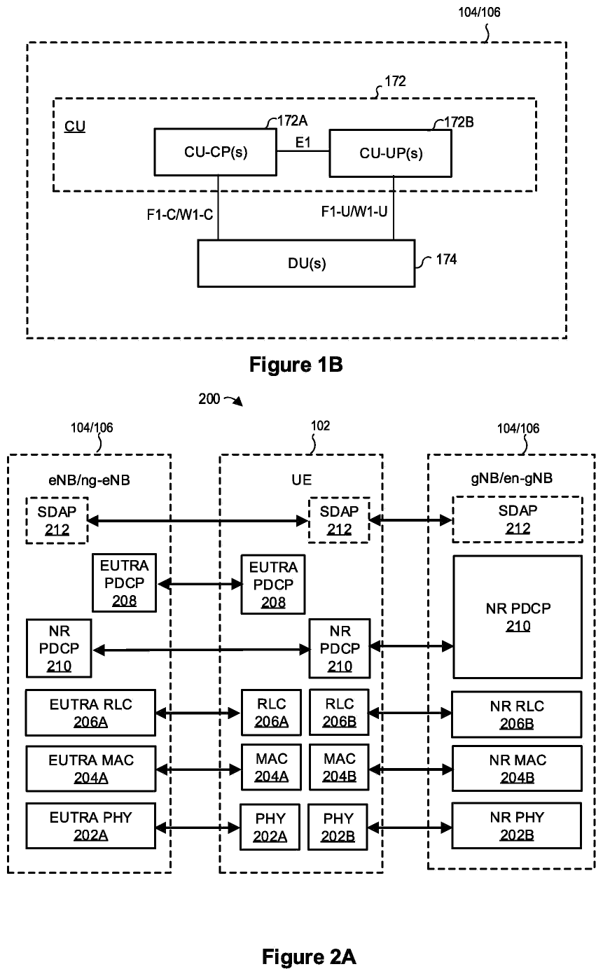

Referring first to FIG. 1A, an example wireless communication system 100 includes a UE 102, a base station (BS) 104, a base station 106, and a core network (CN) 110. The base stations 104 and 106 can operate in a RAN 105 connected to the CN 110. The CN 110 can be implemented as an evolved packet core (EPC) 111 or a fifth generation (5G) core (5GC) 160, for example. The CN 110 can also be implemented as a sixth generation (6G) core, in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 can utilize the techniques of this disclosure for communicating data when the radio connection between the UE 102 and the RAN 105 is suspended, e.g., when the UE operates in an inactive or idle state of the protocol for controlling radio resources between the UE 102 and the RAN 105. For clarity, the examples below refer to the RRC_INACTIVE or RRC_IDLE state of the RRC protocol.

As used in this disclosure, the term “data” or “data packet” refers to signaling, control-plane information at a protocol layer of controlling radio resources (e.g., RRC); controlling mobility management (MM); controlling session management (SM); or non-signaling, non-control-plane information at protocol layers above the layer of the protocol for controlling radio resources (e.g., RRC), above the layer of the protocol for controlling mobility management (MM), above the layer of the protocol for controlling session management (SM), or above the layer of the protocol for controlling quality of service (QOS) flows (e.g., service data adaptation protocol (SDAP)). The data to which the UE and/or the RAN applies the techniques of this disclosure can include, for example, Internet of Things (IoT) data, ethernet traffic data, internet traffic data, or a short message service (SMS) message. Further, as discussed below, the UE 102 in some implementations applies these techniques only if the size of the data is below a certain threshold value.

In the example scenarios discussed below, the UE 102 transitions to the RRC_INACTIVE or RRC_IDLE state, selects a cell of the base station 104, and exchanges data with the base station 104, either via the base station 106 or with the base station 104 directly, without transitioning to RRC_CONNECTED state. As a more specific example, after the UE 102 determines that data is available for uplink transmission in the RRC_INACTIVE or RRC_IDLE state, the UE 102 can apply one or more security functions to the UL data packet, generate a first uplink (UL) protocol data unit (PDU) including the security-protected packet, include a UL RRC message along with the first UL PDU in a second UL PDU, and transmit the second UL PDU to the RAN 105. The UE 102 includes a UE identity/identifier (ID) for the UE 102 in the UL RRC message. The RAN 105 can identify the UE 102 based on the UE ID. In some implementations, the UE ID can be an inactive Radio Network Temporary Identifier (I-RNTI), a resume ID or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105 while in the RRC_INACTIVE or RRC_IDLE state.

In some implementations, the data is a UL service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In further implementations, the UE 102 may not include a UL RRC message in the UL MAC PDU. In this case, the UE 102 may not include a UE ID of the UE 102 in the UL MAC PDU not including a UL RRC message. In yet further implementations, the UE 102 can include the UL PDCP PDU in a UL radio link control (RLC) PDU and then include the UL RLC PDU in the UL MAC PDU. In the case of including the UL RRC message in the UL MAC PDU, the UE 102 in some implementations generates an RRC MAC-I and includes the RRC MAC-I in the UL RRC message. For example, the RRC MAC-I is a resumeMAC-I field, as specified in 3GPP specification 38.331. In further implementations, the UE can obtain the RRC MAC-I from the UL RRC message with an integrity key (e.g., K_{RRCint} key), an integrity protection algorithm, and other parameters COUNT (e.g., 32-bit, 64-bit or 128-bit value), BEARER (e.g., 5-bit value) and DIRECTION (e.g., 1-bit value).

In further implementations, the data is a UL service data unit (SDU) of the NAS. The UE 102 applies the security function to the SDU and includes the secured SDU in a first UL PDU such as a NAS PDU, which can be associated with the NAS layer. For example, the NAS layer can be an MM sublayer or SM sublayer of 5G, Evolved Packet System (EPS), or 6G. Then the UE 102 can include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may not include an RRC MAC-I in the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an encryption and/or decryption key). If the security-protected packet is an integrity-protected packet, the integrity-protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. However, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an encryption and/or decryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 can apply at least one security function to the data to generate a security-protected packet, generate a first DL PDU including the security-protected packet, and the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting the integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU), including the DL RLC PDU, and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In further implementations, the base station may assign the ID of the UE 102 to the UE 102 in an RRC message (e.g., RRC release message or an RRC reconfiguration message) that the base station transmits to the UE 102 before transmitting the DCI and scrambled CRC, e.g., while the UE 102 was in the RRC_CONNECTED state.

The UE 102 operating in the RRC_INACTIVE or RRC_IDLE state can receive the DCI and scrambled CRC on the PDCCH. Then the UE 102 confirms that a physical downlink shared channel (PDSCH), including the second DL PDU, is addressed to the UE 102 according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction, in some scenarios, and receive UL PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes an RRC inactive controller 138 configured to manage early data communication with one or more UEs operating in the RRC_INACTIVE or RRC_IDLE state. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage early data communication when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to, in some scenarios, transmit DL PDCP PDUs in accordance with which the base station 106 can transmit data in the downlink direction, and, in further scenarios, receive UL PDCP PDUs in accordance with which the base station 106 can receive data in the uplink direction. The processing hardware further can include an RRC controller 156 to implement procedures and messaging at the RRC sublayer of the protocol communication stack.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

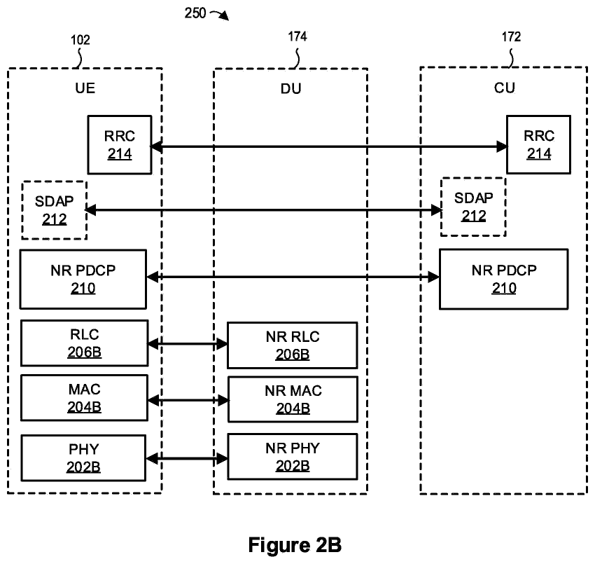

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

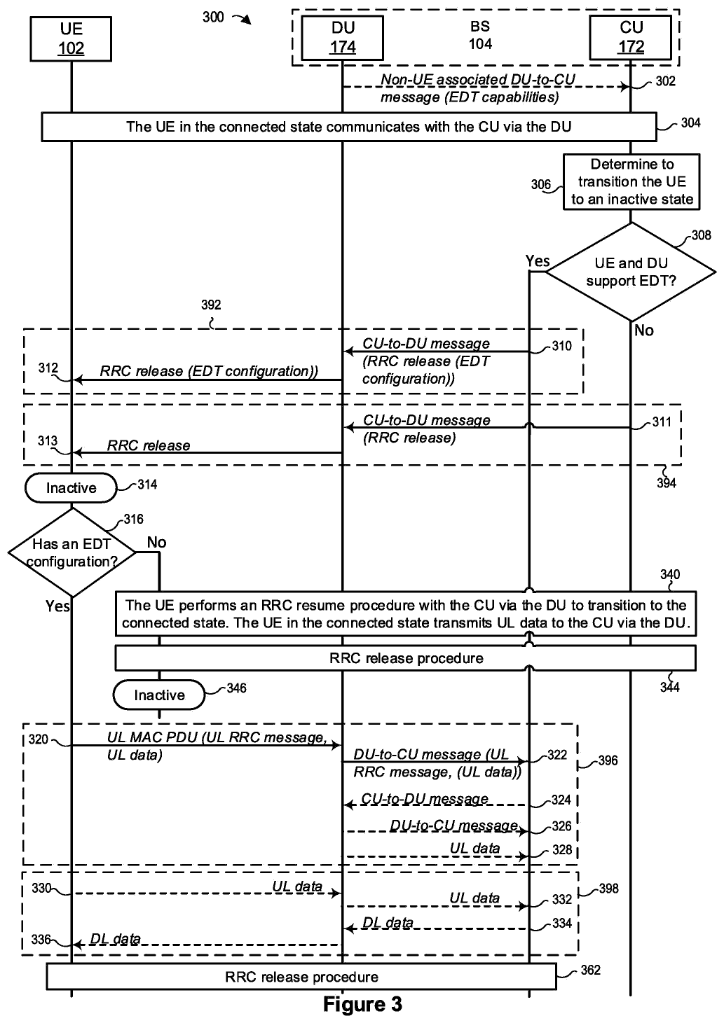

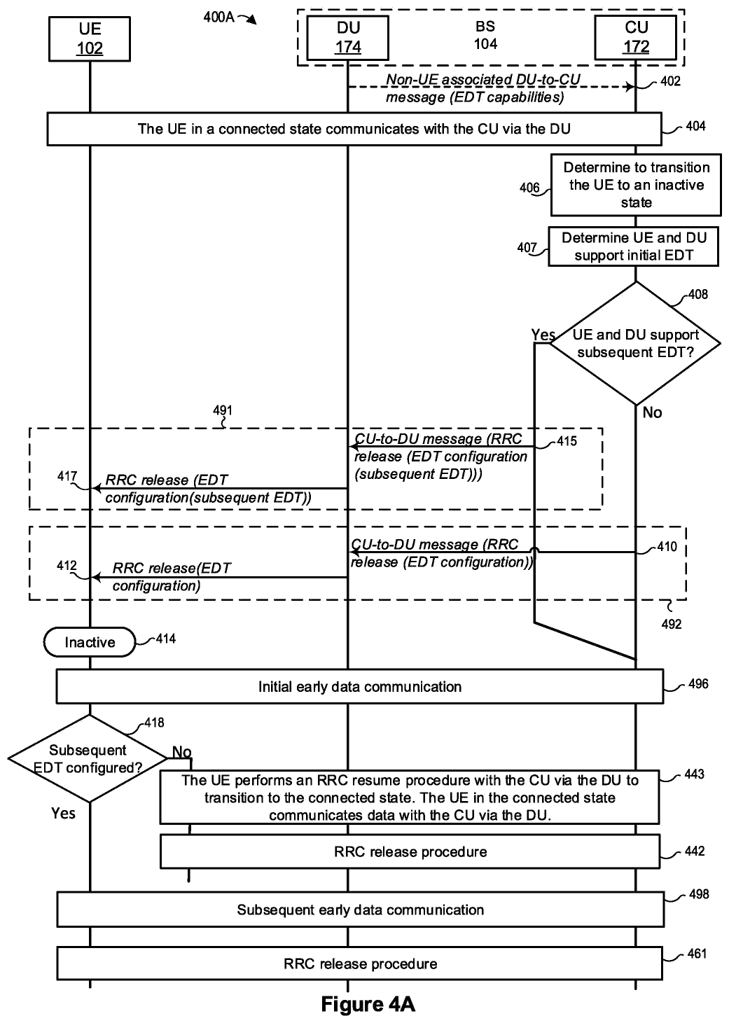

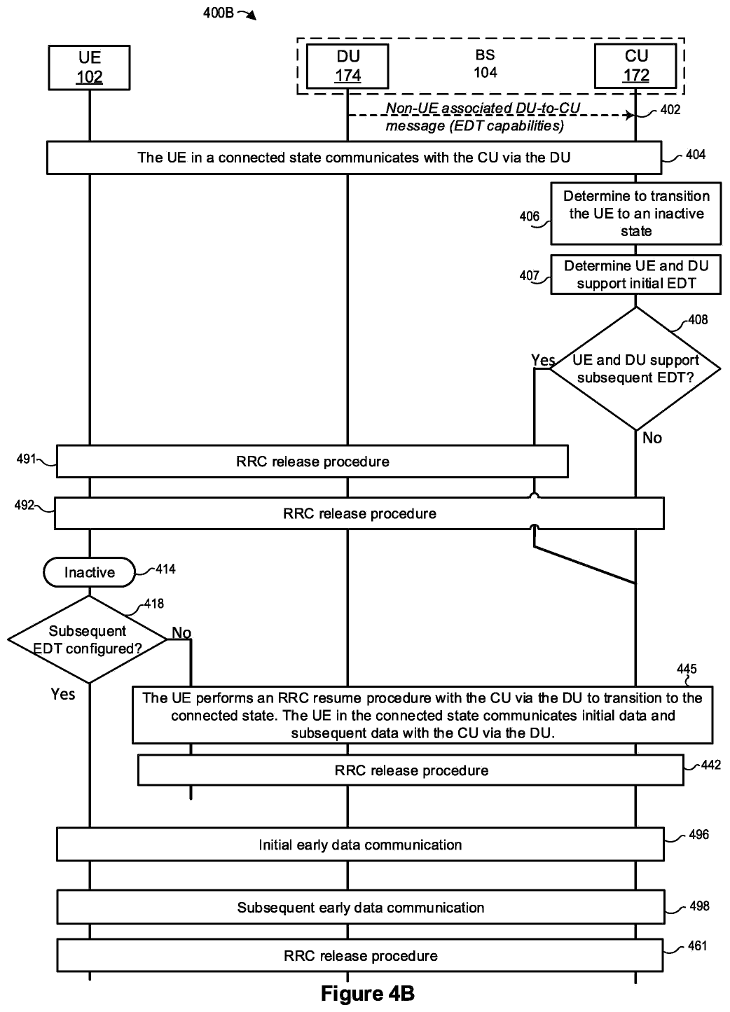

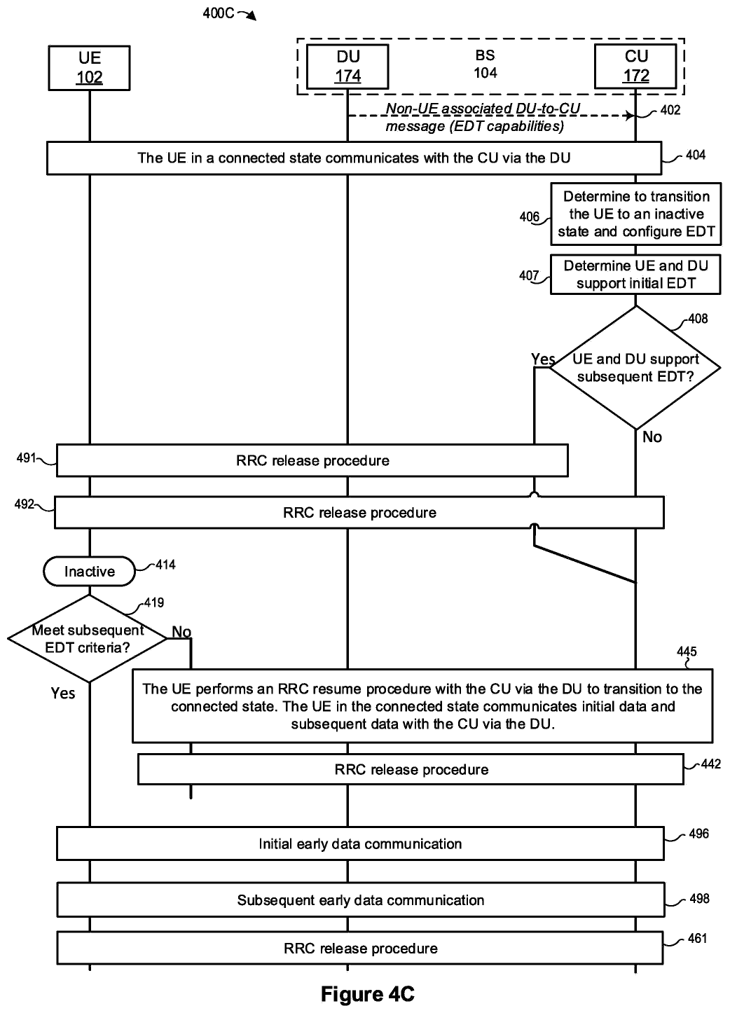

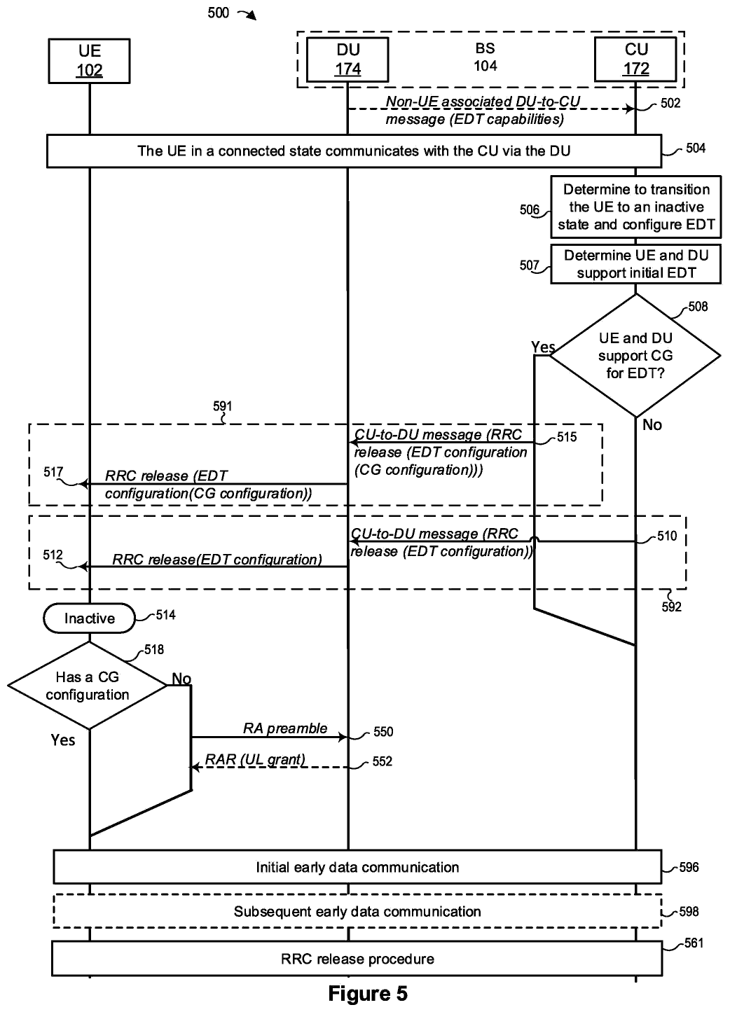

FIGS. 3-5 are messaging diagrams of example scenarios in which a UE and nodes of a RAN implement the techniques of this disclosure for performing early data communication. Generally speaking, events in FIGS. 3-5 that are similar are labeled with similar reference numbers (e.g., event 302 in FIG. 3 is similar to events 402 in FIGS. 4A-4B and event 502 in FIG. 5), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to FIG. 3, in a scenario 300, the UE 102, operating in a connected state (e.g., RRC_CONNECTED), communicates 304 with the base station 104 including a CU 172 and a DU 174. Before the UE 102 is connected to the base station 104, the DU 174 may send a non-UE associated DU-to-CU message including EDT capabilities (i.e., capabilities for DL EDT and/or UL EDT) to the CU 172. The early data communication capabilities indicate whether or not the DU 174 supports EDT.

In some implementations, the DU 174 includes, in the EDT capabilities, specific EDT functions (e.g., subsequent EDT, using a configured grant for EDT, frequency hopping, etc.) that the DU 174 supports or implements. In other implementations, the DU 174 can simply indicate support of EDT, which implies that the DU 174 supports all the necessary functions for EDT. In some implementations, the DU 174 sends the non-UE associated DU-to-CU message after the UE 102 is connected to the base station 104. In yet other implementations, the CU 172 may receive the EDT capabilities from another source (e.g., an operation, administration and maintenance (OAM) node).

In some implementations (not shown), the DU 174 sends 302 the non-UE associated DU-to-CU message to the CU 172 in response to a non-UE associated CU-to-DU message received from the CU 172. In yet other implementations (not shown), the CU 172 can send a non-UE associated CU-to-DU message to the DU 174 in response to the non-UE associated DU-to-CU message. Depending on the implementation, the non-UE associated DU-to-CU message may be an F1 Setup Request message, a gNB-DU Configuration Update message, or a DU Capability Information message. If the non-UE associated DU-to-CU message is a DU Capability Information message, the non-UE associated CU-to-DU message may be a DU Capability Enquiry message.

In some scenarios and implementations, the UE 102 in the connected state communicates 304 data with the CU 172 and the DU 174, e.g., via one or more radio bearers (RBs). The UE 102 in the connected state communicates the control-plane (CP) data via one or more signaling RBs (SRBs). The UE 102 in the connected state communicates the user-plane (UP) data via one or more data RBs (DRBs). The CU 172 can determine that neither the CU 172 nor the UE 102 has transmitted any data in the downlink direction or the uplink direction, respectively, during a (first) certain period. In some implementations (not shown), the DU 174 can send to the CU 172 a DU-to-CU message indicating data inactivity with the UE 102 over the (first) certain period. Thus, the CU 172 can determine the data inactivity for the UE 102 by taking into account the explicit data inactivity indication from the DU 174. In response to the determination, the CU 172 can determine 306 to transition the UE 102 to an inactive state (e.g., RRC_INACTIVE) from the connected state.

After or in response to the determination 306, the CU 172 determines 308 whether the DU 174 and the UE 102 support EDT. The CU 172 determines whether the DU 174 supports EDT based on the EDT capabilities that the CU 172 receives 302 from the DU 174. Similarly, the CU 172 can additionally or alternatively determine whether the UE 102 supports EDT based on capability information for the UE 102, which the CU 172 can receive, for example, from the UE 102 while communicating 304 with the UE 102. In some implementations, the CU 172 also determines whether the CU 172 itself supports EDT. In other implementations, the CU 172 may implicitly be aware of the capabilities of the CU 172, and may not need to check whether the CU 172 supports EDT. Generally speaking, the remaining discussion presumes that the CU 172 supports EDT.

Based on whether the DU 174 and the UE 102 support EDT, the CU 172 determines whether to include an EDT configuration in a message to the UE 102. The message may be an RRC release message (e.g., an RRCRelease message) that instructs the UE 102 to transition to the inactive state. If the DU 174 and the UE 102 (and the CU 172) support EDT, then the CU 172 includes, in an RRC release message, an EDT configuration. The CU 172 transmits 310 a CU-to-DU message (e.g., a UE Context Release Command message) including the RRC release message to the DU 174, which retrieves the RRC release message and transmits 312 the RRC release message including the EDT configuration to the UE 102. The events 310 and 312 are collectively referred to an RRC release procedure 392. If the DU 174 or the UE 102 (or the CU 172) do not support EDT, then the CU 172 excludes, from an RRC release message to the UE 102, an EDT configuration. The CU 172 transmits 311 a CU-to-DU message (e.g., a UE Context Release Command message) including the RRC release message to the DU 174, which in turn retrieves the RRC release message and transmits 313 the RRC release message excluding the EDT configuration to the UE 102. The events 311 and 313 are collectively referred to as an RRC release procedure 394.

In some implementations, the EDT configuration includes one or more EDT initiation criteria configurations, a configured grant (CG) configuration, multiple CG configurations, a configuration of HARQ retransmission with the CG configuration(s), a subsequent EDT configuration, a repetition configuration, a PDCCH configuration, a PUCCH configuration, and/or a PUSCH configuration. In some implementations, the one or more EDT initiation criteria configurations can include at least one signal strength threshold, a maximum data volume size, a maximum packet size, and/or a maximum number of packets for an EDT session. For example, the at least one signal strength threshold can be a reference signal received power (RSRP) threshold, reference signal received quality (RSRQ) threshold, and/or signal to noise and interference ratio (SINR) threshold. The UE 102 can initiate EDT (i.e., initiate uplink EDT) only if at least one signal strength value obtained by the UE 102 from measurements are above the at least one threshold. In some implementations, the maximum data volume size specifies a maximum number of octets for all EDT RBs that the UE 102 can transmit in an EDT session. In some implementations, the maximum packet size specifies a maximum number of octets that the UE 102 can transmit in a single EDT (i.e., an uplink MAC PDU). In other implementations, the maximum packet size specifies a maximum number of octets for a single packet that the UE 102 can transmit. The single packet can be an application data packet (e.g., IP packet or Ethernet packet), an SDAP PDU, an NAS PDU, an RRC PDU, a PDCP SDU, a PDCP PDU or an RLC PDU.

In some implementations, the subsequent EDT configuration enables the UE 102 to communicate subsequent UL or DL data in an EDT session. In cases where the UE 102 does not have the subsequent EDT configuration, the UE 102 refrains from transmitting subsequent UL data in an EDT session. In some implementations, the repetition configuration enables or configures the UE 102 to transmit repetitions (i.e., retransmissions) of a UL transmission (e.g., a PUSCH transmission or a UL MAC PDU) in an EDT session without receiving a HARQ negative acknowledgement. In cases where the UE 102 does not have the repetition configuration, the UE 102 can refrain from transmitting repetitions for a UL transmission during EDT.

In some implementations, each of the CG configurations(s) can include a time domain resources allocation configuration, a frequency domain resources allocation configuration, a HARQ configuration, one or more EDT initiation criteria configurations, a repetition configuration, a PDCCH configuration, a PUCCH configuration, a PUSCH configuration, a configuration of HARQ retransmission, a frequency hopping configuration, and/or a physical layer acknowledgement configuration, which are specific for EDT using radio resources configured by the CG configuration(s). In other implementations, the CG configuration can include configuration parameters similar to configuration parameters included in a ConfiguredGrantConfiguration IE specified in 3GPP specification 38.331.

In the EDT configuration, the CU 172 in some implementations can indicate at least one RB (RB(s)) in the one or more RBs as EDT RB(s) (i.e., the RB(s) suitable or configured for EDT) or non-EDT RB(s) (i.e., the RB(s) unsuitable or not configured for EDT). For example, the CU 172 can include an EDT indication in the RRC release message to indicate a first SRB of the one or more RBs as an EDT SRB. In cases where the CU 172 does not include an EDT indication for a second SRB in the one or more RBs in the RRC release message, the second SRB is implicitly designated as a non-EDT SRB. Alternatively, the CU 172 can include an explicit non-EDT indication in the RRC release message to indicate the second SRB as a non-EDT SRB. In another example, the CU 172 can include an EDT indication in the RRC release message to indicate a first DRB of the one or more RBs as an EDT DRB. In cases where the CU 172 does not include an EDT indication for a second DRB in the one or more RBs in the RRC release, the second DRB is implicitly designated as a non-EDT DRB. Alternatively, the CU 172 can include an explicit non-EDT indication in the RRC release message to indicate the second DRB as a non-EDT DRB.

In alternative implementations, the CU 172 can send at least one DL RRC message (e.g., RRC reconfiguration message, RRC resume message or RRC setup message) to the UE 102 to indicate the RB(s) as EDT RB(s) or non-EDT RB(s) via the DU 174 or another DU, while the UE 102 operates 304 in the connected state. To indicate a particular RB of the RB(s) as an EDT RB or non-EDT RB, the CU 172 in some implementations can generate a radio bearer configuration (RadioBearerConfig) IE including the indication(s) and include the RadioBearerConfig IE in one of the at least one DL RRC message. For example, the CU 172 can include an EDT indication in a first one of the DL RRC message to indicate a first SRB of the one or more SRBs as an EDT SRB. In cases where the CU 172 does not include an EDT indication for a second SRB in the one or more SRBs in a second one of the at least one DL RRC message, the second SRB is a non-EDT SRB (i.e., the second SRB unsuitable or not configured for EDT). Alternatively, the CU 172 can include a non-EDT indication in the second DL RRC message to indicate the second SRB as a non-EDT SRB. In another example, the CU 172 can include an EDT indication in a third one of the at least one DL RRC message to indicate a first DRB of the one or more DRBs as an EDT DRB. In cases where the CU 172 does not include an EDT indication for a second DRB in the one or more DRBs in a fourth one of the at least one DL RRC message, the second DRB is a non-EDT DRB (i.e., the second DRB unsuitable or not configured for EDT). Alternatively, the CU 172 can include a non-EDT indication in the fourth DL RRC message to indicate the second DRB as a non-EDT DRB. The first, second, third, and/or fourth DL RRC messages can be the same message or different messages.

In yet alternative implementations, particular RB(s) (e.g., SRB0, SRB1, and/or SRB2) in the one or more RBs can be designated as EDT RB(s) by default, even though the CU 172 does not explicitly indicate the particular RB(s) in the one or more RBs as EDT RB(s). In such implementations, the UE 102 determines the particular RB(s) as EDT RB(s), even though the UE 102 does not receive from the CU 172 indication(s) to indicate the particular RB(s) as EDT RB(s). In such implementations, the CU 172 determines the particular RB(s) as EDT RB(s), even though the CU 172 does not transmit to the UE 102 indication(s) to indicate the particular RB(s) as EDT RB(s).

The UE 102 transitions 314 to the inactive state upon receiving the RRC release message. The CU 172 can assign an I-RNTI or a resume ID to the UE 102 and include the assigned value in the RRC release message. In some embodiments, after the UE 102 transitions to the inactive state, the UE 102 may perform one or more RAN notification area (RNA) updates with the CU 172 via the DU 174 without state transitions.

At a later time, the UE 102 determines to transmit UL data to the base station 104. To determine how to transmit the UL data to the base station 104, the UE 102 determines 316 whether the UE 102 has an EDT configuration and that the UL data conforms to the EDT configuration. In particular, depending on whether the UE 102 has an EDT configuration, the UE 102 can determine whether to initiate 320 EDT or perform 340 an RRC resume procedure in order to transmit the UL data.

In cases where the UE 102 has an EDT configuration (e.g., the EDT configuration that the UE received at event 312 and the UL data conforms to the EDT configuration), the UE 102 can initiate 396 the initial early data communication. Initial early data communication refers to communication of a first data packet during an EDT session. In response to or after initiating 396 the initial early data communication, the UE 102 generates an initial UL MAC PDU including a UL RRC message and initial UL data and transmits 320 the initial UL MAC PDU to the DU 174 on the cell 124. The DU 174 retrieves the UL RRC message and the initial UL data from the initial UL MAC PDU and generates a first DU-to-CU message (e.g., an Initial UL RRC Message Transfer message) including the UL RRC message. Then, the DU 174 sends 322 the first DU-to-CU message to the CU 172. After receiving or in response to the first DU-to-CU message, the CU 172 in some implementations can send 324 a first CU-to-DU message to the DU 174 to establish a UE Context of the UE 102 at the DU 174. In response, the DU 174 sends 326 a second DU-to-CU message to the CU 172. In some implementations, the DU 174 can include the initial UL data in the first DU-to-CU message as shown. In other implementations, the DU 174 can send 328 the initial UL data to the CU 172 separately after transmitting 322 the first DU-to-CU message, receiving 324 the first CU-to-DU message, or transmitting 326 the second DU-to-CU message. In some implementations, the CU 172 can include a UL tunnel endpoint identifier (TEID) in the first CU-to-DU message and the DU 174 sends 328 to the CU 172 a tunnel packet including the initial UL data and UL TEID.

The UE 102 can determine 316 whether UL data qualifies for transmission in the inactive state in view of one or more factors as whether the data is an IMS packet; whether the UL data is associated with a radio bearer (e.g., DRB or SRB) not suitable or configured for early data transmission; or whether the data is an NAS message for initiating a particular NAS procedure, the size of the data, etc. When the UL data qualifies for transmission in the inactive state, the UL data is hereinafter referred to as EDT UL data. For example, the UL data is associated to an EDT RB (e.g., EDT SRB or EDT DRB). Otherwise, the UL data is hereinafter referred to as non-EDT UL data. For example, the UL data is associated to non-EDT RB (e.g., non-EDT SRB or non-EDT DRB) or is not associated to an EDT RB (e.g., EDT SRB or EDT DRB). If the DL data qualifies for transmission in the inactive state, the DL data is hereinafter referred to as EDT DL data. For example, the DL data is associated to an EDT RB (e.g., EDT SRB or EDT DRB). Otherwise, the DL data is hereinafter referred to as non-EDT DL data. For example, the DL data is associated to non-EDT RB (e.g., non-EDT SRB or non-EDT DRB) or is not associated to an EDT RB (e.g., EDT SRB or EDT DRB).

In some implementations, the UL RRC message is an (existing) RRC resume request message (e.g., an RRCResumeRequest message, an RRCResumeRequest1 message, an RRCConnectionResumeRequest message, or an RRCConnectionResumeRequest1 message). In other implementations, the UL RRC message can be a new RRC resume request message, similar to the existing RRC resume request message. For example, the new RRC resume request message is defined as a format of an RRC release or version later than an RRC release or version of the existing RRC resume request message. In some implementations, the UL RRC message can include an EDT indication which can be a field or information element (IE) (e.g., resumeCause or ResumeCause). In some implementations, the UL RRC message is a common control channel (CCCH) message.

In some implementations, the UE 102 in the inactive state can perform a random access procedure with the DU 174 to transmit the initial UL MAC PDU at event 320. Further details are provided in FIG. 5 and the accompanying text. For example, the random access procedure can be a four-step random access procedure or a two-step random access procedure. In the case of the four-step random access procedure, the UE 102 transmits a random access preamble to the base station 104 and, in response, the base station 104 transmits to the UE 102 a random access response (RAR) including an uplink grant, and the UE 102 transmits 320 the UL MAC PDU in accordance with the uplink grant. The DU 174 receives 320 the UL MAC PDU in accordance with the uplink grant in the RAR. In the case of the two-step random access procedure, the UE 102 transmits 320 to the DU 174 a message A including a random access preamble and the UL MAC PDU in accordance with two-step random access configuration parameters. The UE 102 receives the two-step random access configuration parameters in system information broadcast by the DU 174 on cell 124 before transmitting 320 the UL MAC PDU. The DU 174 receives 320 the UL MAC PDU in accordance with the two-step random access configuration parameters. In further implementations, the UE 102 can transmit 320 the UL MAC PDU on radio resources configured in a configured grant (CG) configuration. The CU 172 can obtain the CG configuration from the DU 174 and include the CG configuration to the UE 102 in the RRC release message. Thus, the DU 174 receives 320 the UL MAC PDU on the radio resources. In such implementations, the UE 102 can transmit 316 and/or 330 the UL MAC PDU(s) on radio resources configured in the CG configuration. In cases where the RRC release message includes other CG configuration(s), the UE 102 can transmit 316 and/or 330 the UL MAC PDU(s) on radio resources configured in the other CG configuration(s).

In some implementations, the first CU-to-DU message of event 324 and the second DU-to-CU message of event 326 are a UE Context Setup Request message and a UE Context Setup Response message, respectively. In other implementations, the first CU-to-DU message and the second DU-to-CU message are new F1 application protocol (F1AP) messages or W1 application protocol (W1AP) messages, respectively.

The events 320, 322, 324, 326 and 328 are collectively referred to in FIG. 3 as an initial early data communication 396.

After transmitting 320 the initial UL MAC PDU, the UE 102 and the base station 104 may perform subsequent EDT to exchange one or more additional packets during the EDT session. As will be discussed below with reference to FIGS. 4A-4C, the EDT configuration may enable the UE 102 to perform subsequent EDT. If the EDT configuration enables the UE 102 to perform subsequent EDT, then the UE 102 in the inactive state can transmit 330 subsequent UL data (e.g., one or more UL data packets) to the DU 174, which in turn send 332 the UL data to the CU 172. More specifically, the UE 102 can generate one or more subsequent UL MAC PDUs including the UL data and transmit 330 the subsequent UL MAC PDUs to the DU 174. In some implementations or scenarios, the UE 102 in the inactive state can transmit 330 to the DU 174 one or more subsequent UL MAC PDU (UL MAC PDU(s)), each including a particular subsequent UL data packet. The DU 174 retrieves the particular UL data packet from each of the subsequent UL MAC PDU(s) and send 332 each retrieved UL data packet to the CU 172. In other implementations or scenarios, the UE 102 in the inactive state can segment a subsequent UL data packet into multiple segments and transmit 330 multiple subsequent UL MAC PDUs, each including a particular segment of the multiple segments. After receiving the multiple UL MAC PDUs, the DU 174 assembles all the segments to obtain the subsequent UL data packet and sends 322 the UL data packet to the CU 172. In yet other implementations or scenarios, the UE 102 in the inactive state can transmit 330 to the DU 174 a subsequent UL MAC PDU including subsequent UL data packets. The DU 174 retrieves the subsequent UL data packets from the subsequent UL MAC PDU and send 332 the subsequent UL data packets to the CU 172.

Further, if the EDT configuration enables the UE 102 to perform subsequent EDT, then, in the downlink direction, after receiving 322 the first DU-to-CU message, receiving 326 the second DU-to-CU message, or receiving 328 the UL data, the CU 172 can send 334 DL data (e.g., one or more DL data packets) to the DU 174, which in turn sends 336 the DL data to the UE 102 operating in the inactive state. More specifically, the DU 174 can generate one or more DL MAC PDUs including the DL data and transmit 336 the DL MAC PDUs to the UE 102. In some implementations or scenarios, the CU 172 can send 334 one or more DL data packets to the DU 174. In one implementation, the DU 174 generates one or more DL MAC PDUs each including a particular DL data packet of the one or more DL data packets and transmits 336 the one or more DL MAC PDUs to the UE 102. In another implementation, the DU 174 can segment a DL data packet in the one or more DL data packet into multiple segments and transmit 336 multiple DL MAC PDUs each including a particular segment of the multiple segments. After receiving the multiple DL MAC PDUS, the UE 102 assembles all the segments to obtain the DL data packet. In yet another implementation, the DU 174 can include multiple DL data packets of the one or more DL data packets in a DL MAC PDU and transmit the DL MAC PDU to UE 102. The UE 102 retrieves the DL data packets from the DL MAC PDU.

The (UL/DL) data packet in some example scenarios is an Internet Protocol (IP) packet, an Ethernet packet or an application packet. In other scenarios, the data packet is a PDU (e.g., SDAP PDU, RRC PDU, PDCP PDU, RLC PDU or MAC PDU) that includes an RRC message, a NAS message, an IP packet, an Ethernet packet, or an application packet. Still further, the data packet in some scenarios can be an RRC PDU including an NAS PDU, such that the NAS PDU includes an IP packet, an Ethernet packet, or an application packet.

The events 330, 332, 334, and 336 are collectively referred to in FIG. 3 as a subsequent early data communication 398. The subsequent UL EDT (i.e., events 330, 332) and the subsequent DL EDT (i.e., events 334 and 336) can occur in parallel or in series.

If the EDT configuration does not enable the UE 102 to perform subsequent EDT, but the UE 102 has additional data to transmit to the CU 172 via the DU 174, then the UE 102 can perform a successive initial early data communication to transmit the additional data. Specifically, after performing 396 the initial early data communication to transmit a first data packet, the UE 102 can perform 362 RRC release procedure with the base station 104. The UE 102 can then perform a successive initial EDT session, similar to event 396, to transmit a second data packet. Alternatively, the UE 102 can perform an RRC resume procedure, similar to event 340, to transition to the connected state to transmit the second data packet.

In some implementations, the CU 172 can retrieve an IP packet, an Ethernet packet or a NAS PDU from the UL data packets received from the UE 102 in the initial early data communication 396 or the subsequent early data communication 398, and send the IP packet, the Ethernet packet, or the NAS PDU to the CN 110 (e.g., SGW 112, UPF 162, MME 114, or AMF 164) or an edge server. In some implementations, the edge server can operate within the RAN 105. In other implementations, the CU 172 can retrieve an RRC PDU or RRC message from the UL data packets received from the UE 102 in the initial early data communication 396 or the subsequent early data communication 398, and process the RRC PDU or RRC message.

After a (second) certain period of data inactivity for the UE 102, similar to the determination with respect to the first certain period of data inactivity, the CU 172 can determine that neither the CU 172 nor the UE 102 has transmitted any data in the downlink direction or the uplink direction after the initial early data communication 396 and/or the subsequent early data communication 398, respectively, during the (second) certain period. In response to the determination, the CU 172 can perform 362 an RRC release procedure with the UE 102 similar to the RRC release procedure 392. The UE 102 remains in the inactive state in response to or after performing 362 the RRC release procedure. In some implementations, the CU 172 can set the second certain period different from the first certain period. For example, the second certain period can be shorter than the first certain period. In another example, the second certain period can be longer than the first certain period. In other implementations, the first and second certain periods are the same.

The RRC release procedure 362 ends the EDT session. Accordingly, the EDT session in FIG. 3 includes the initial early data communication 396 and the subsequent early data communication 398.

In cases where the UE 102 has no EDT configuration at event 316 (or has an EDT configuration but the UL data does not quality for transmission in the inactive state), the UE 102 can perform 340 an RRC resume procedure with the CU 172 via the DU 174 to transition to a connected state. The UE 102 transitions to the connected state in response to the RRC resume procedure. The UE 102 in the connected state transmits 340 the initial data to the CU 172 via the DU 174. The UE 102 in the connected state can also transmit additional UL data to the CU 172 via the DU 174 and/or receive DL data from the CU 172 via DU 174. In the RRC resume procedure, the UE 102 sends an RRC resume request message to the CU 172 via the DU 174. More specifically, the UE 102 transmits a first UL MAC PDU including the RRC resume request message to the DU 174, which in turn sends a DU-to-CU message including the RRC resume request message to the CU 172, similar to events 320, 322. In contrast to event 320, the UE 102 does not include UL data in the first UL MAC PDU. In response to the RRC resume request message, the CU 172 sends to the UE 102 via the DU 174 an RRC resume message to transition the UE 102 to the connected state. In response to the RRC resume message, the UE 102 transitions to the connected state and transmits an RRC resume complete message to the CU 172 via the DU 174. More specifically, the UE 102 transmits a second UL MAC PDU including the RRC resume complete message to the DU 174, which in turn sends a DU-to-CU message (e.g., UL RRC Message Transfer message) including the RRC resume complete message to the CU 172.

As mentioned above, even if the UE 102 has an EDT configuration at event 316, the UE 102 may perform 340 the RRC resume procedure if the UL data does not qualify for transmission in the inactive state. The UE 102 can then transmit the UL data to the CU 172 via the DU 174 in the connected state.

In some implementations, the UE 102 in the connected state can include the initial UL data in the second UL MAC PDU. In other implementations, the UE 102 in the connected state can include a portion of the initial UL data in the second UL MAC PDU and transmits one or more UL MAC PDU including the rest portion(s) of the initial UL data to the DU 174. In yet other implementations, the UE 102 in the connected state can send one or more UL MAC PDUs including the initial UL data to the DU 174 after transmitting the RRC resume complete message. After transmitting the initial UL data, the UE 102 in the connected state can send subsequent UL data to the CU 172 via the DU 174 and/or receive DL data from the CU 172 via the DU 174.

After a (third) certain period of data inactivity for the UE 102, similar to the determination with respect to the first or second certain period of data inactivity, the CU 172 can determine that neither the CU 172 nor the UE 102 has transmitted any data in the downlink direction or the uplink direction after event 340, respectively, during the (third) certain period. In response to the determination, the CU 172 can perform 344 an RRC release procedure with the UE 102 similar to the RRC release procedure 394. The UE 102 returns to the inactive state in response to or after performing 344 the RRC release procedure. In some implementations, the CU 172 can set the third certain period different from the first or second certain period. For example, the third certain period can be shorter than the first or second certain period. In another example, the third certain period can be longer than the first or second certain period. In other implementations, the first and third certain periods are the same. In response to performing 344 the RRC release procedure with the CU 172, the UE 102 transitions 346 to the inactive state.

In the scenario 300, the UE 102 initiates the EDT session by initiating 396 the initial early data communication. In other scenarios, the CU 172 may initiate the EDT session. The CU 172 may detect DL data addressed to the UE 102. In response, the CU 172 can determine whether the CU 172 transmitted 310 an EDT configuration to the UE 102. If so, then the CU 172 can transmit a paging message to the UE 102 via the DU 174 including an EDT indication, which instructs the UE 102 to perform EDT to receive the DL data without transitioning to the connected state. To perform the EDT, the UE 102 can transmit an UL RRC message to the CU 172 via the DU 174, similar to event 320, except that the UE 102 does not include UL data with the UL RRC message. After receiving the UL RRC message via the DU 174, similar to event 322, the CU 172 can transmit the DL data to the CU 172 via the DU 174. If the CU 172 has not transmitted an EDT configuration to the UE 102, the CU 172 can transmit a paging message to the UE 102 via the DU 174 excluding an EDT indication, which causes the UE 102 to perform 340 an RRC resume procedure with the CU 172 in order to transition to the connected state to receive the DL data. Thus, while the scenarios illustrated in FIGS. 3-5 depict initial early data communication as UL EDT, in other scenarios, the initial early data communication can be DL EDT. In such scenarios, the CU 172, rather than the UE 102, determines whether the UE 102 has received an EDT configuration, and transmits the initial DL data packet via either EDT or by transitioning the UE 102 to the connected state.

Turning to FIG. 4A, a scenario 400A is initially similar to the scenario 300 and then focuses on subsequent EDT configurations, procedures, and communications. After communicating 404 with the UE 102 while the UE 102 operates in a connected state, the CU 172 determines 406 to transition the UE 102 to the inactive state, similar to event 306. The CU 172 also determines, based on capability information for the DU 174 (i.e., EDT capabilities) and capability information for the UE 102, that the DU 174 and the UE 102 support initial EDT. Initial EDT includes communicating a single, first data packet during an EDT session. However, as discussed above, EDT may include other functions, including subsequent EDT. The DU 174 and/or the UE 102 may only support certain functions related to EDT. Subsequent EDT, for example, is more complex than initial EDT. In some cases, the DU 174 and/or the UE 102 may only support communicating a single data packet during an EDT session, and may not support subsequent EDT (i.e., may not support transmitting more than one data packet during an EDT session). Support for initial EDT may be referred to in this disclosure as “basic EDT.”

Accordingly, the CU 172 also determines whether the UE 102 and the DU 174 support subsequent EDT. If so, then the CU 172 includes a subsequent EDT configuration in the EDT configuration, and includes the EDT configuration in an RRC release message. The CU 172 then transmits 415 a CU-to-DU message including the RRC release message to the DU 174, which retrieves the RRC release message from the CU-to-DU message and transmits 417 the RRC release message to the UE 102. The events 415 and 417 are collectively referred to as an RRC release procedure 491. If either of the UE 102 or the DU 174 do not support subsequent EDT, then the CU 172 excludes a subsequent EDT configuration from the EDT configuration. The CU 172 includes the EDT configuration in an RRC release message and transmits 410 a CU-to-DU message including the RRC release message to the DU 174, which retrieves the RRC release message and transmits 412 the RRC release message to the UE 102. The events 410 and 412 are collectively referred to as an RRC release procedure 492.

In response to receiving 417 or 412 the RRC release message, the UE 102 transitions 414 to the inactive state. While operating in the inactive state, the UE 102 detects a first data packet for transmission to the CU 172. In response, the UE 102 can perform 496 initial early data communication in order to transmit the first data packet to the CU 172 via the DU 174. Before, during, or after 496 the initial early data communication, and before receiving an RRC release message (i.e., before the EDT session ends), the UE 102 detects a second data packet (or a plurality of data packets) for transmission to the CU 172. For example, when the UE 102 detects the first data packet, the UE 102 may detect a plurality of data packets including the first data packet. As another example, the UE 102 may detect the second data packet or a plurality of data packets after transmitting the first data packet.

In any event, after detecting the second data packet, the UE 102 determines 418 whether the UE 102 has received a subsequent EDT configuration (i.e., whether subsequent EDT is configured at the UE 102). If not, then in some implementations, the UE 102 performs 443 an RRC resume procedure with the CU 172 via the DU 174 to transition to the connected state, and communicates the second data packet (and any other subsequent UL or DL data) with the CU 172 via the DU 174, similar to event 340. At a later time, the CU 172 may determine to transition the UE 102 to the inactive state, and perform 442 an RRC release procedure with the UE 102, similar to event 492. In other implementations (not shown), the UE 102 and BS 104 perform an RRC release procedure, similar to event 492, 442, or 344, to complete the EDT session including the initial early data communication 496, and then the UE 102 initiates a second EDT session to transmit the second data packet as a successive initial early data communication.

If the UE 102 has received a subsequent EDT configuration, then the UE 102 utilizes the subsequent EDT configuration to perform 498 subsequent early data communication with the CU 172. During the subsequent early data communication 498, the UE 102 communicates the second data packet (and any other subsequent UL or DL data) with the CU 172 via the DU 174. At a later time, the CU 172 can determine to transition the UE 102 to the inactive state, and perform 461 an RRC release procedure with the UE 102, similar to event 491 or 362. The initial data communication 496 and the subsequent early data communication 498 are during the same EDT session, which ends in response to the RRC release procedure 461.

Turning to FIG. 4B, a scenario 400B is generally similar to the scenarios 400A and 300. However, in contrast to FIG. 4A, the UE 102 determines 418 whether subsequent EDT is configured prior to transmitting a first data packet. For example, the UE 102 may detect a plurality of data packets including at least a first data packet and a second data packet for transmission to the CU 172. If the UE 102 is not configured to perform subsequent EDT, then, in some implementations, the UE 102 may perform 445 an RRC resume procedure to transition to the connected state (without performing an initial early data communication), as illustrated in FIG. 4B. While operating in the connected state, the UE 102 can transmit both the first and second data packets to the CU 172 via the DU 174. Alternatively, in other scenarios (not shown), the UE 102 can transmit the first data packet during a first initial EDT session, and transmit the second data packet during a successive (initial) EDT session as described with reference to FIGS. 3 and 4A.

If the UE 102 is configured to perform subsequent EDT, then the UE 102 performs 496 initial early data communication to transmit the first data packet to the CU 172 via the DU 174, and later performs 498 subsequent early data communication to transmit the second data packet to the CU 172. The UE 102 therefore transmits the first and second data packets to the CU 172 during the same EDT session.

Turning to FIG. 4C, a scenario 400C is similar to the scenario 400B. Prior to event 419, the UE 102 detects a plurality of packets including at least a first data packet and a second data packet. However, in contrast to event 418, the UE 102 determines 419 whether the plurality of data packets meets subsequent EDT criteria. If so, then the UE 102 performs 496 initial early data communication and performs 498 subsequent EDT to transmit the plurality of packets to the CU 172 via the DU 174. Otherwise, the UE 102 transitions 445 to the connected state to communicate both the first data packet and subsequent data packets of the plurality of data packets.

Subsequent EDT criteria is included in a subsequent EDT configuration. Accordingly, if the UE 102 has not received a subsequent EDT configuration, then the UE 102 does not meet the subsequent EDT criteria. If the UE 102 has received a subsequent EDT configuration, then the UE 102 determines 419 whether the UE 102 meets the criteria for performing subsequent EDT.

For example, the subsequent EDT criteria includes a maximum number (e.g., N) of packets that the UE 102 can transmit in during an EDT session (i.e., the initial and subsequent EDT). The UE 102 in the inactive state may have M UL data packets available for transmission. If M<=N, then the UE 102 can perform 496 the initial early data communication and perform 498 the subsequent early data communication with the CU 172 and DU 174 to transmit the M UL data packets. Otherwise, if M>N, the UE 102 performs 445 the RRC resume procedure with the CU 172 via the DU 174 to transition to the connected state. The UE 102 in the connected state transmits the M UL data packets to the CU 172 via the DU 174. Alternatively, the UE 102 can transmit the M UL data packets during at least M/N successive EDT sessions (i.e., by performing 496 initial early data communication at least M/N times, and performing 442 an RRC release procedure after each initial early data communication of up to N packets).

In some implementations, the subsequent EDT criteria may include a maximum data volume size. If the total data size of the M UL data packets>the maximum data volume size, the UE 102 performs 445 the RRC resume procedure with the CU 172 via the DU 174 to transition to the connected state and the UE 102 in the connected state transmits the M UL data packets to the CU 172 via the DU 174. In cases where M<=N, if the total data size of the M UL data packets<=the maximum data volume size, UE 102 can perform 496 the initial early data communication and perform 498 the subsequent early data communication with the CU 172 and DU 174 to transmit the M UL data packets.

In some implementations, the subsequent EDT criteria may include a maximum packet size. If one of the M UL data packets>the maximum packet size, the UE 102 performs 445 the RRC resume procedure with the CU 172 via the DU 174 to transition to the connected state and the UE 102 in the connected state transmits the M UL data packets to the CU 172 via the DU 174. In cases where M<=N, if each of the M UL data packets<=the maximum packet size, the UE 102 can perform 496 the initial early data communication and perform 498 the subsequent early data communication with the CU 172 and DU 174 to transmit the M UL data packets.

Turning to FIG. 5, a scenario 500 is similar to the scenario 400A. However, instead of determining 408 whether the DU 174 and the UE 102 both support subsequent EDT, the CU 172 determines 508 whether the DU 174 and the UE 102 both support using a configured grant (CG) for EDT. If so, then the CU 172 includes a CG configuration in an EDT configuration, which the CU 172 includes in an RRC release message. The CU 172 includes the RRC release message in a CU-to-DU message and transmits 515 the CU-to-DU message to the DU 174, which retrieves the RRC release message and transmits 517 the RRC release message to the UE 102. The events 515 and 517 are collectively referred to as an RRC release procedure 591. If either of the DU 174 or the UE 102 do not support using a CG for EDT, then the CU 172 excludes a CG configuration from the EDT configuration. The CU 172 transmits 510 a CU-to-DU message to the DU 174 including an RRC release message that includes the EDT configuration excluding the CG configuration. The DU 174 transmits 512 the RRC release message to the UE 102. The events 510 and 512 are collectively referred to as an RRC release procedure 592.

In response to receiving 517 or 512 the RRC release message, the UE 102 transitions 514 to the inactive state. If the UE 102 has pending data (e.g., one UL data packet or a plurality of data packets) to transmit to the CU 172, the UE 102 determines 518 whether the UE 102 has received a CG configuration. If not, then the UE 102 performs a random access procedure in order to initiate EDT. The UE 102 can perform a four-step or a two-step random access procedure. In the case of the four-step random access procedure, the UE 102 transmits 550 an RA preamble to the DU 174. In response, the DU 174 transmits 552 an RAR including an uplink grant. The UE 102 can perform 596 initial early data communication to transmit the first UL data packet to the CU 172 via the DU 174 in accordance with the uplink grant. In the case of a two-step random access procedure, the UE 102 transmits 550 a random access preamble and an UL MAC PDU in a Message A to the DU 174. The UL MAC PDU includes an UL RRC message. In some implementations, the UL MAC PDU also includes the first UL data packet. Otherwise, the UE 102 can transmit the first UL data packet after transmitting the UL RRC message. In the case of the two-step random access procedure, the DU 174 refrains from transmitting an RAR including an UL grant.

After transmitting the first UL data packet, the UE 102 can perform 598 subsequent early data communication to communicate subsequent data packets with the CU 172 via the DU 174, provided the UE 102 has a subsequent EDT configuration and the subsequent data packets meet any subsequent EDT criteria included in the subsequent EDT configuration based on the principles described with respect to FIGS. 4A, 4B, and/or 4C.

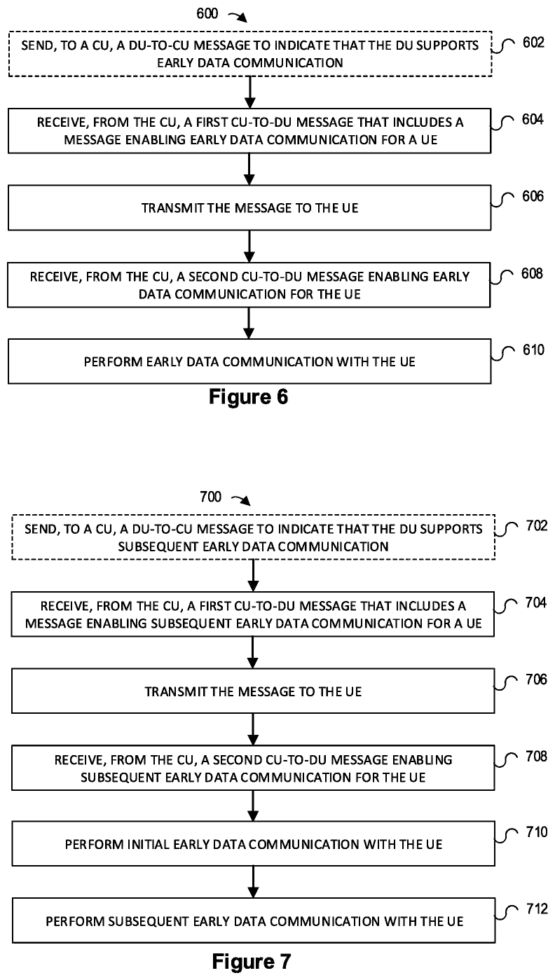

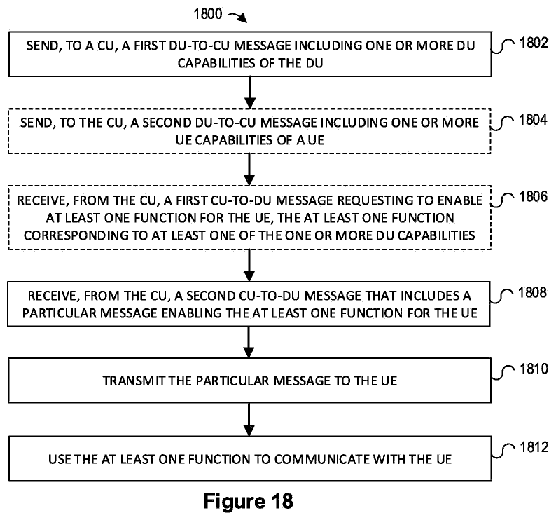

FIGS. 6-25 are flow diagrams depicting example methods that a network node of a RAN (e.g., a network node of the RAN 105, such as the DU 174, the CU 172, or the base station 104) or a UE (e.g., the UE 102) can implement to manage early data communication, or, in some cases, to implement DU capability reporting related to other functions (discussed with reference to FIGS. 18-21).

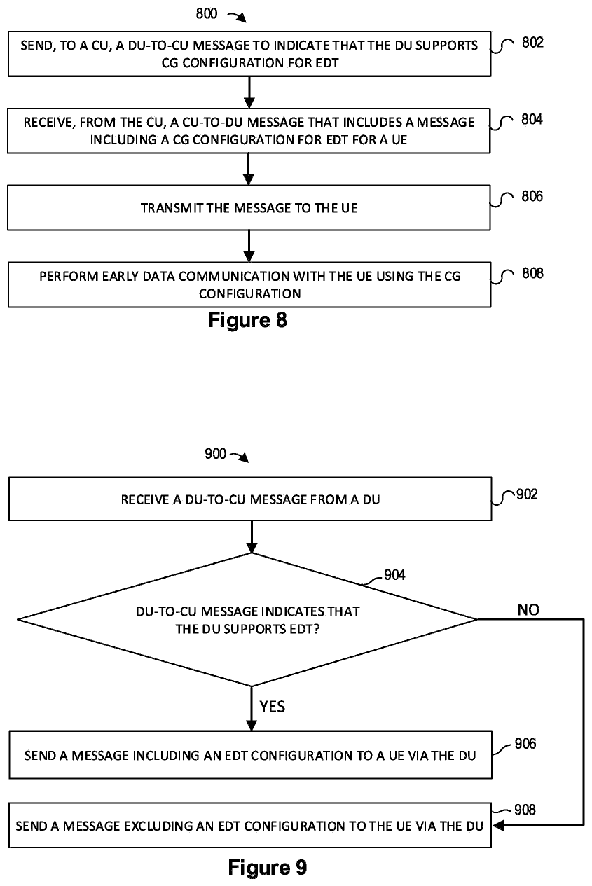

Turning first to FIG. 6, a DU (e.g., the DU 174) can implement a method 600 to perform early data communication with a UE (e.g., the UE 102). The method 600 can be augmented with elements from FIG. 7 and/or FIG. 8. At block 602, the DU may send, to a CU (e.g., the CU 172) a DU-to-CU message to indicate that the DU supports early data communication (e.g., events 302, 402, 502). For example, the DU may send a DU-to-CU message including EDT capabilities to the CU. In other implementations, the CU may receive capabilities of the DU from another source such as an OAM node, or may be preconfigured with the capabilities of the DU.

At block 604, the DU receives, from the CU, a first CU-to-DU message that includes a message enabling early data communication for the UE (e.g., events 310, 415, 410, 515, 510). For example, the message may be an RRC release message including an EDT configuration. At block 606, the DU transmits the message to the UE (e.g., events 312, 417, 412, 517, 512). At block 608, the DU receives, from the CU, a second CU-to-DU message enabling early data communication for the UE (e.g., event 324). The second CU-to-DU message may be a UE Context Setup Request message, a new F1AP message, or a new W1AP message. The CU-to-DU message may include an indication notifying the DU that the CU is performing early data communication with the UE via the DU. For example, the CU-to-DU message may indicate an RRC state of the UE (e.g., RRC_INACTIVE). The RRC state may indicate to the DU that the CU is performing early data communication (i.e., if the RRC state is an inactive state, then the DU can determine that the CU is performing early data communication). After receiving the second CU-to-DU message, the DU can perform early data communication with the UE at block 610 (e.g., event 328).

Turning to FIG. 7, a DU (e.g., the DU 174) can implement a method 700 specifically for performing subsequent early data communication with a UE (e.g., the UE 102). At block 702, the DU may send, to a CU (e.g., the CU 172) a DU-to-CU message to indicate that the DU supports subsequent early data communication (e.g., events 302, 402, 502), similar to block 602. At block 704, the DU receives, from the CU, a first CU-to-DU message that includes a message enabling subsequent early data communication for the UE (e.g., event 415). For example, the message may be an RRC release message including a subsequent EDT configuration. At block 706, the DU transmits the message to the UE (e.g., event 417). At block 708, the DU receives, from the CU, a second CU-to-DU message enabling subsequent early data communication for the UE (e.g., an event similar to event 324 during procedure 496). After receiving the second CU-to-DU message, the DU can perform initial early data communication with the UE at block 710 (e.g., event 496), and subsequent early data communication with the UE at block 712 (e.g., event 498).

Turning to FIG. 8, a DU (e.g., the DU 174) can implement a method 800 specifically for performing early data communication with a UE (e.g., the UE 102) using a CG configuration. At block 802, the DU sends, to a CU (e.g., the CU 172), a DU-to-CU message indicating that the DU supports early data communication using a CG configuration (e.g., event 502). At block 804, the DU receives, from the CU, a CU-to-DU message that includes a CG configuration for the UE to use for performing EDT (e.g., event 515). For example, the message may be an RRC release message including an EDT configuration that includes a CG configuration. At block 806, the DU transmits the message to the UE (e.g., event 517). The DU can then perform early data communication with the UE using the CG configuration (e.g., event 596).

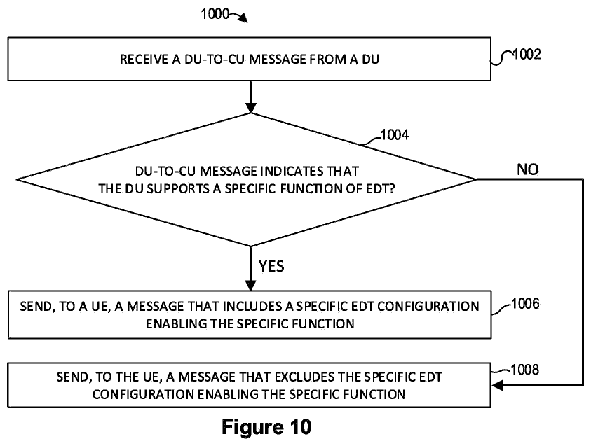

FIG. 9 is a flow diagram of a method 900 for determining whether to send an EDT configuration to a UE (e.g., the UE 102), which can be implemented by a CU (e.g., the CU 172). The method 900 can be augmented with elements from FIG. 10. At block 902, the CU receives a DU-to-CU message from a DU (e.g., the DU 174) (e.g., events 302, 402, 502). At block 904, the CU determines whether the DU-to-CU message indicates that the DU supports EDT (e.g., based on EDT capabilities included in the DU-to-CU message) (e.g., event 308). If so, then at block 906 the CU sends a message including an EDT configuration to a UE via the DU (e.g., event 310). The message can be an RRC message, such as an RRC release message. Otherwise, the flow proceeds to block 908, where the CU sends a message excluding an EDT configuration to the UE via the DU (e.g., event 311).

FIG. 10 is a flow diagram of an example method 1000 for determining whether to enable a UE (e.g., the UE 102) to use an EDT-related function, which can be implemented by a CU (e.g., the CU 172). At block 1002, the CU receives a DU-to-CU message from a DU (e.g., the DU 174) (e.g., events 302, 402, 502). At block 1004, the CU determines whether the DU-to-CU message indicates that the DU supports a specific function of EDT (e.g., based on EDT capabilities included in the DU-to-CU message) (e.g., events 408, 508). Example specific functions include: subsequent EDT, using a CG configuration for EDT, repetitions during EDT, HARQ retransmissions with a CG configuration for EDT, frequency hopping for EDT, or a physical layer acknowledgement for EDT. If the DU supports the specific function, then the CU sends, to the UE, a message that includes an EDT configuration element enabling the specific function (e.g., events 415, 417, 515, 517), at block 1006. Otherwise, at block 1008, the CU sends, to the UE, a message excluding the specific EDT configuration (e.g., events 410, 412, 510, 512). The message may include a basic EDT configuration (i.e., a configuration for performing initial early data communication). In some alternative implementations, the CU can receive a message indicating whether the DU supports a specific function of EDT from an OAM node instead of receiving the DU-to-CU message from the DU. The CU determines whether the message indicates that the DU supports a specific function of EDT.

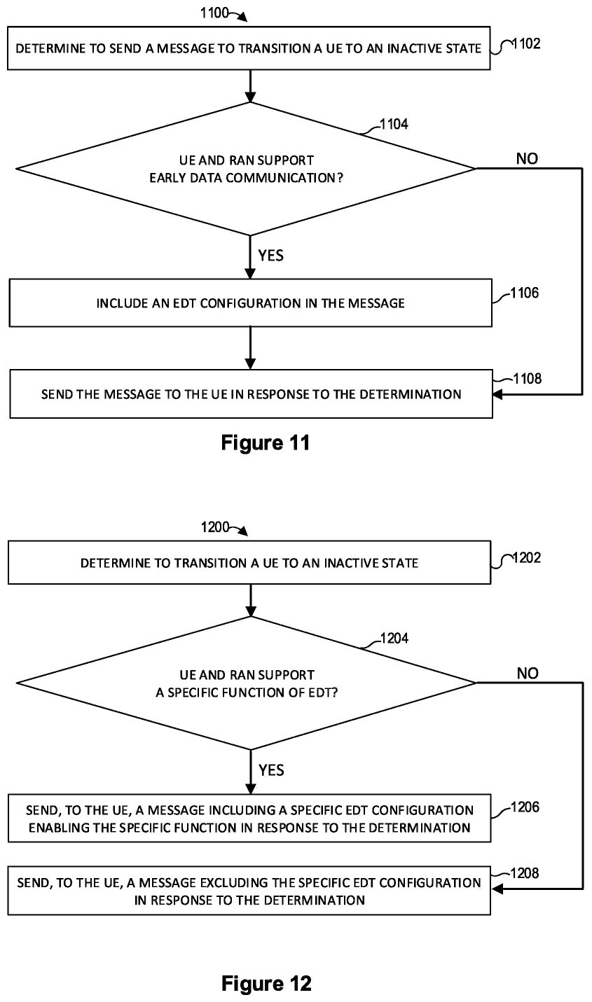

FIG. 11 is a flow diagram of a method 1100 for determining whether to send an EDT configuration to a UE (e.g., the UE 102), which can be implemented by a RAN (e.g., the RAN 105). The method can be implemented by, for example, a CU (e.g., the CU 172) or a base station (e.g., the base station 104). At block 1102, the RAN determines to send a message to transition the UE to an inactive state (e.g., an RRC release message). At block 1104, the RAN determines whether both the UE and the RAN (i.e., the CU and the DU) support early data communication (e.g., event 308). If so, then at block 1106 the RAN includes an EDT configuration in the message and transmits, at block 1108, the message to the UE in response to the determination at block 1102 (e.g., events 310, 312). Otherwise, the flow proceeds directly to block 1108 and the message does not include an EDT configuration (e.g., events 311, 313).

FIG. 12 is a flow diagram of a method 1200 for determining whether to enable a UE (e.g., the UE 102) to use an EDT-related function, which can be implemented by a RAN (e.g., the RAN 105). The method can be implemented by, for example, a CU (e.g., the CU 172) or a base station (e.g., the base station 104). At block 1202, the RAN determines to send a message to transition the UE to an inactive state (e.g., an RRC release message). At block 1204, the RAN determines whether both the UE and the RAN (i.e., the CU and the DU) support a specific function of EDT (e.g., events 408, 508). Similar to FIG. 10, example specific functions include: subsequent EDT, using a CG configuration for EDT, repetitions during EDT, HARQ retransmissions with a CG configuration for EDT, frequency hopping for EDT, or a physical layer acknowledgement for EDT. If so, then at block 1206 the RAN includes a specific EDT configuration enabling the specific function in the message and transmits, at block 1208, the message to the UE in response to the determination at block 1202 (e.g., events 415, 417, 515, 517). Otherwise, the flow proceeds directly to block 1208 and the message does not include a specific EDT configuration (e.g., events 410, 412, 510, 512). The message may include a basic EDT configuration.

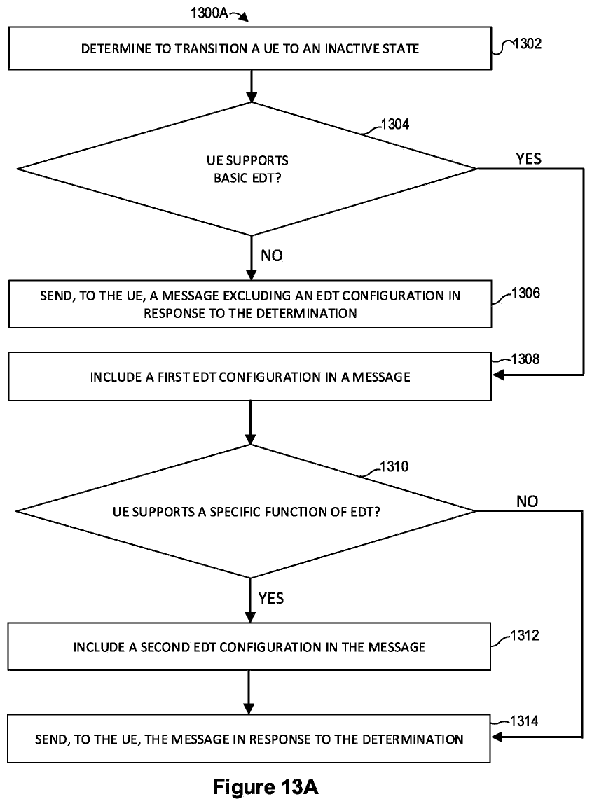

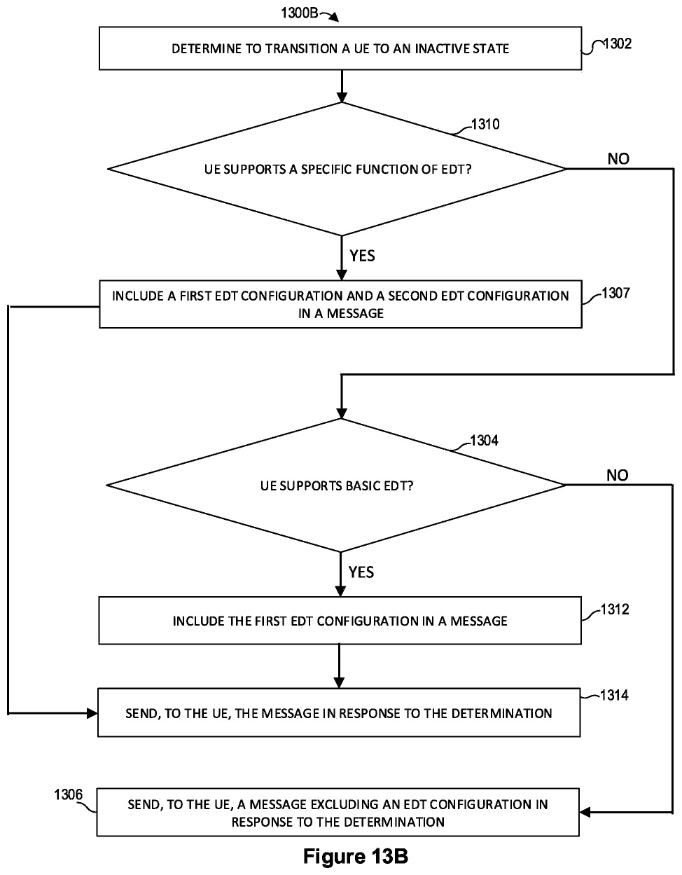

FIG. 13A illustrates a method 1300A for configuring a UE (e.g., the UE 102) to perform EDT and EDT-related functions, which can be implemented by a RAN (e.g., the RAN 105). At block 1302, the RAN determines to transition the UE to an inactive state. At block 1304, the RAN determines whether the UE supports basic EDT (i.e., supports at least initial EDT). If not, then the flow proceeds to block 1306, where the RAN sends a message to the UE excluding an EDT configuration (e.g., events 311, 313). Otherwise, the flow proceeds to block 1308, where the RAN includes a first EDT configuration in a message for the UE. At block 1310, the RAN determines whether the UE supports a specific function of EDT (e.g., the specific functions discussed with reference to FIGS. 10 and 12). If so, then the RAN includes a second EDT configuration in the message at block 1312. For example, the RAN can include a specific EDT configuration for the specific function in the first EDT configuration. At block 1314, the RAN transmits the message to the UE in response to the determination at block 1302. If the UE does not support the specific function, then the flow proceeds directly from block 1310 to block 1314, and the RAN omits the second EDT configuration from the message.

FIG. 13B illustrates a method 1300B that is similar to the method 1300A, except that the order of blocks 1310 and 1314 is changed. Thus, after determining at block 1302 to transition the UE to the inactive state, the RAN determines at block 1310 whether the UE supports a specific function of EDT. If so, then at block 1307 the RAN includes a first EDT configuration and a second EDT configuration in a message (e.g., an RRC release message). If the RAN determines that the UE supports the specific function, then then RAN can determine that the UE also supports basic EDT. Accordingly, the first EDT configuration may be for basic EDT, and the second EDT configuration may be for the specific function. The flow can then proceed from block 1307 to block 1314, where the RAN sends the message to the UE in response to the determination at block 1302.

If the UE does not support the specific function, then the flow proceeds to block 1304, where the RAN determines whether the UE supports basic EDT (i.e., supports at least initial EDT). If not, then at block 1306 the RAN can send a message to the UE in response to the determination at block 1302, the message excluding an EDT configuration. If the UE does support basic EDT, then the RAN can include the first EDT configuration in a message at block 1312, and transmit the message to the UE at block 1314.

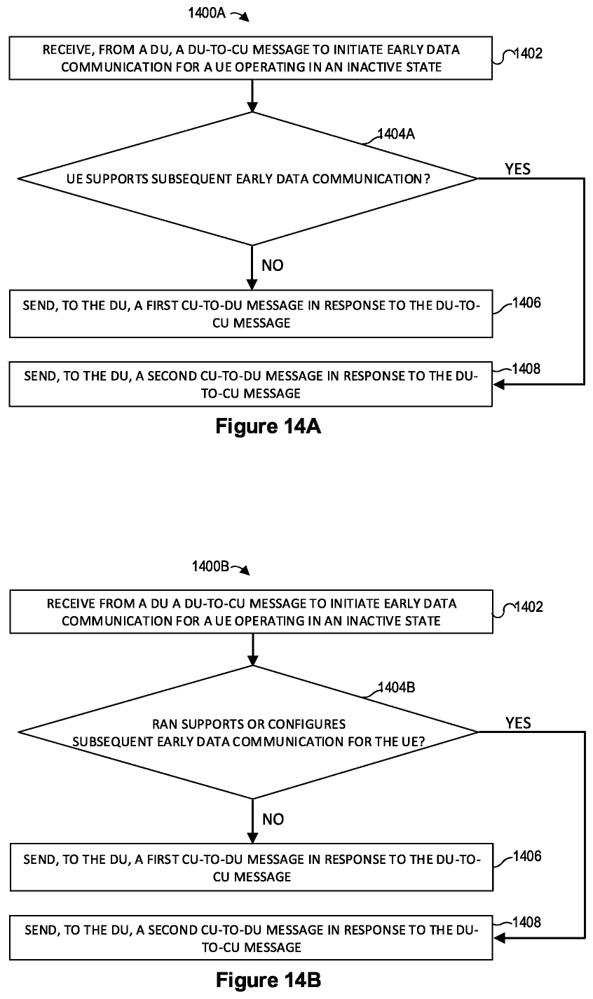

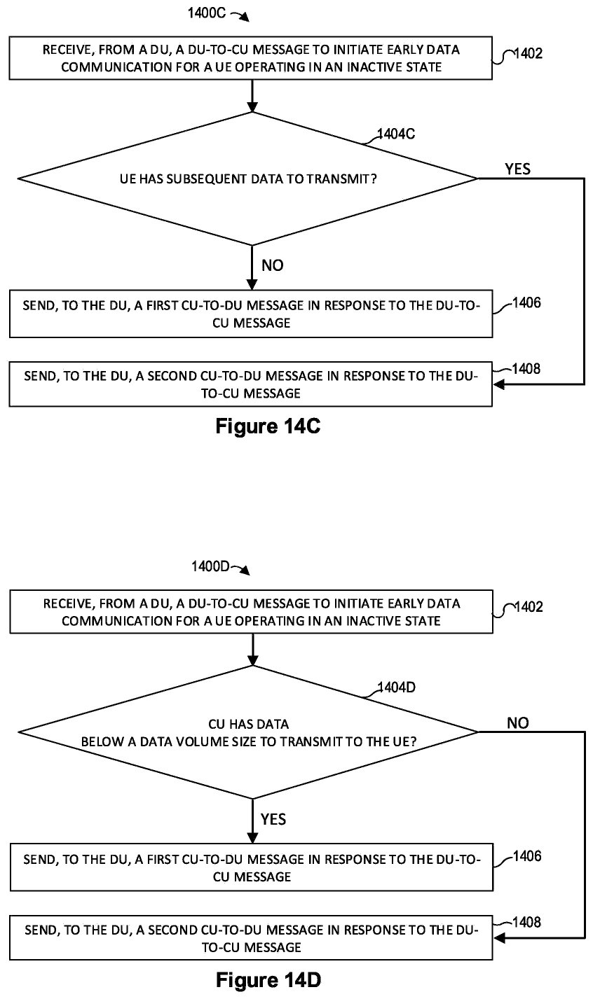

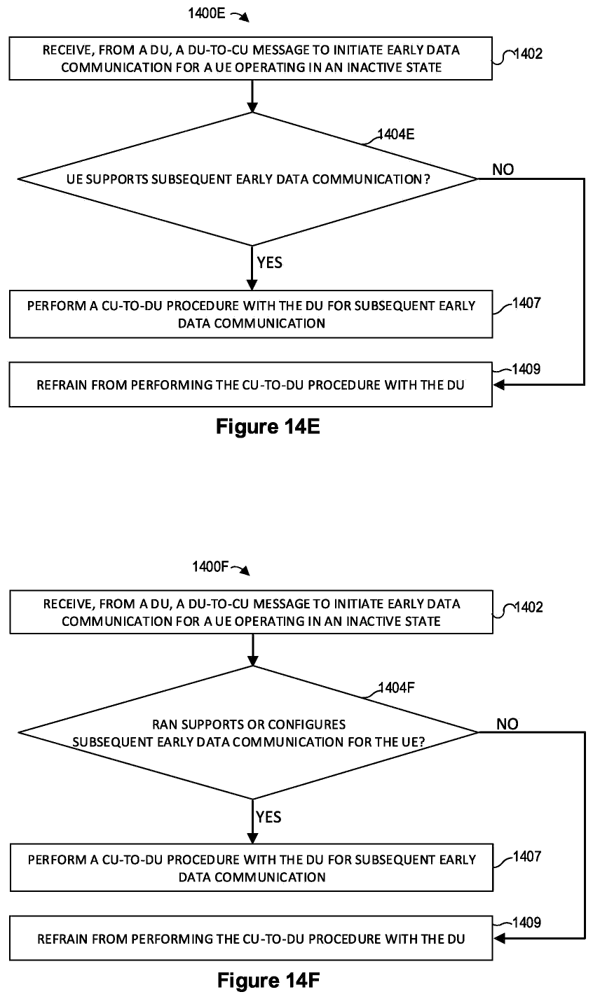

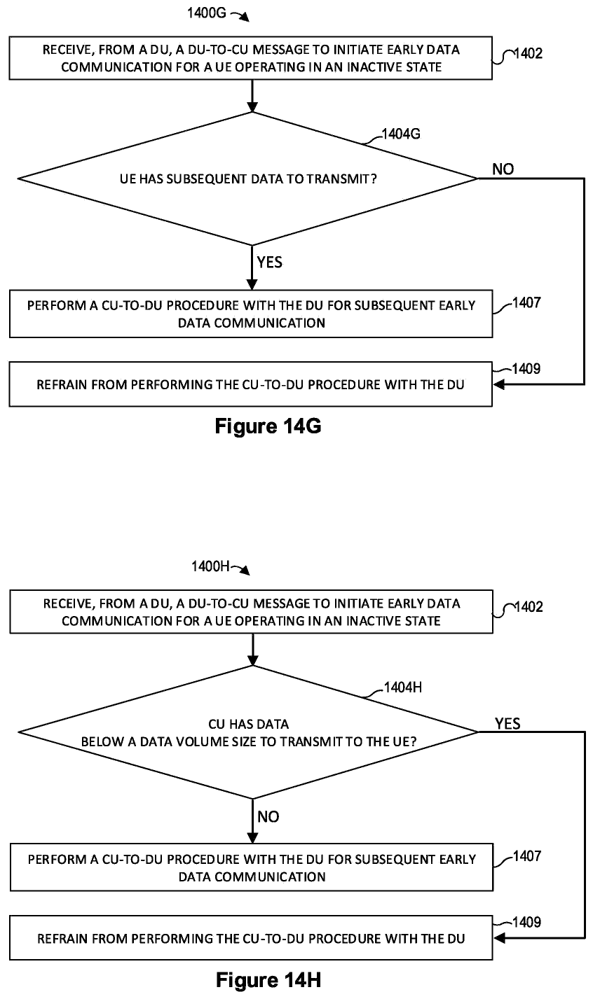

FIG. 14A is a flow diagram of a method 1400A for configuring early data communication based on whether a UE (e.g., the UE 102) supports subsequent early data communication, which can be implemented by a CU (e.g., the CU 172). The method 1400A (and the methods described with reference to FIGS. 14B-14H) can be augmented with elements from FIG. 13A or 13B, with FIGS. 13A-13B describing EDT configuration, which may occur prior to the methods in FIG. 14A-H. At block 1402, the CU receives, from a DU (e.g., the DU 174), a DU-to-CU message to initiate early data communication for a UE operating in an inactive state (e.g., event 322). The DU-to-CU message may include an UL RRC message that the DU received from the UE (e.g., event 320), and may include UL data that the DU received from the UE with the UL RRC message. At block 1404A, the CU determines whether the UE supports subsequent early data communication. If not, then at block 1406, the CU sends, to the DU, a first CU-to-DU message in response to the DU-to-CU message. The first CU-to-DU message includes an RRC release message (e.g., as in the RRC release procedure 392). If the UE does support subsequent early data communication, then at block 1408, the CU sends, to the DU, a second CU-to-DU message in response to the DU-to-CU message (e.g., event 324). The second CU-to-DU message may be a request to establish a UE Context of the UE at the DU.

FIG. 14B illustrates a method 1400B, which is similar to the method 1400A. However, in contrast to block 1404A, at block 1404B, the CU determines whether the RAN supports or configures subsequent early data communication for the UE. If not, then the CU sends the first CU-to-DU message to the DU at block 1406. If the RAN does support or configure subsequent early data communication for the UE, then at block 1408 the CU can send the second CU-to-DU message to the DU.

FIG. 14C illustrates a method 1400C, which is similar to the method 1400A. However, in contrast to block 1404A, at block 1404C, the CU determines whether the UE has subsequent data to transmit. For example, the CU can determine that the UE has subsequent data to transmit based on an indication that the CU receives in an UL RRC message from the UE. The UL RRC message may be included in the DU-to-CU message that the CU receives at block 1402. As another example, the UE can include a buffer status report (BSR) in an UL MAC PDU that the UE transmits to the DU (e.g., event 320). The DU can include the BSR or an indication of the BSR in the DU-to-CU message that the DU transmits to the CU at block 1402, and the CU can determine based on the BSR whether the UE has subsequent data to transmit. If the UE does not have subsequent data to transmit, then the CU sends the first CU-to-DU message to the DU at block 1406. Otherwise, then at block 1408 the CU can send the second CU-to-DU message to the DU.

FIG. 14D illustrates a method 1400D, which is similar to the method 1400A. However, in contrast to block 1404A, at block 1404D, the CU determines whether the CU has data to transmit to the UE, and whether that data is below a data volume size. The data volume size may be a maximum data volume size for EDT. If the CU does not have data for the UE or if the data is below the data volume size, the CU sends the first CU-to-DU message to the DU at block 1406. If the CU has data for the CU that is larger than the data volume size, then at block 1408 the CU can send the second CU-to-DU message to the DU.

FIG. 14E is a flow diagram of an example method 1400E, which is similar to the method 1400A. In particular, block 1404E is similar to block 1404A. If the UE supports subsequent early data communication, then at block 1407, the CU performs a CU-to-DU procedure with the DU for subsequent early data communication (e.g., events 324 and 326, similar to block 1408). Otherwise, at block 1409, the CU refrains from performing the CU-to-DU procedure with the DU. The CU may transmit, after block 1409, a CU-to-DU message to the DU including an RRC release message for the UE (e.g., similar to block 1406).

FIG. 14F is a flow diagram of a method 1400F, which is similar to the method 1400B. Block 1404F is similar to block 1404B. If the RAN supports or configures subsequent early data communication for the UE, then the flow proceeds to block 1407. Otherwise, the flow proceeds to block 1409.

FIG. 14G is a flow diagram of a method 1400G, which is similar to the method 1400C. Block 1404G is similar to block 1404C. If the UE has subsequent data to transmit, then the flow proceeds to block 1407. Otherwise, the flow proceeds to block 1409.

FIG. 14H is a flow diagram of a method 1400H, which is similar to the method 1400D. Block 1404H is similar to block 1404D. If the CU has data to transmit to the UE, and that data is below a data volume size for the UE, then the flow proceeds to block 1407. Otherwise, the flow proceeds to block 1409.

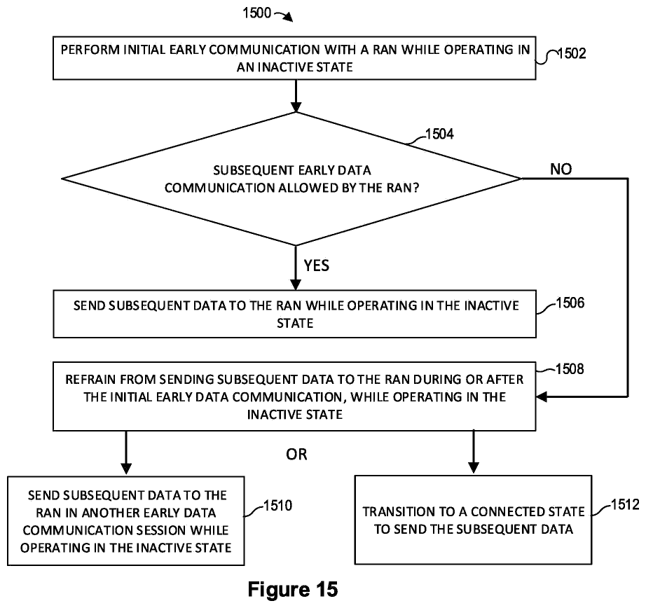

Turning to FIG. 15, a UE (e.g., the UE 102) can implement a method 1500 to determine whether to perform subsequent early data communication. At block 1502, the UE performs initial early data communication with a RAN (e.g., the RAN 105) while operating in an inactive state (e.g., RRC_INACTIVE) (e.g., event 496). At block 1504, the UE determines whether subsequent early data communication is allowed by the RAN. In particular, the UE may determine whether the RAN configured the UE to perform subsequent early data communication (e.g., event 418). If subsequent early data communication is allowed by the RAN, then the UE sends subsequent data to the RAN while operating in the inactive state at block 1506 (e.g., event 498). Otherwise, the UE refrains from sending subsequent data to the RAN during or after the initial early data communication, while operating in the inactive state. The UE therefore does not send subsequent data to the RAN during the same EDT session as the initial early data communication. Instead, in some implementations, the flow proceeds to block 1510, where the UE sends subsequent data to the RAN in another EDT session while operating in the inactive state. Accordingly, after the initial early data communication, the UE can perform an RRC release procedure with the RAN. The UE can then perform initial early data communication to transmit the subsequent data (e.g., event 496). In other implementations, the flow proceeds to block 1512, where the UE transitions to a connected state (e.g., RRC_CONNECTED) to send the subsequent data (e.g., event 443).

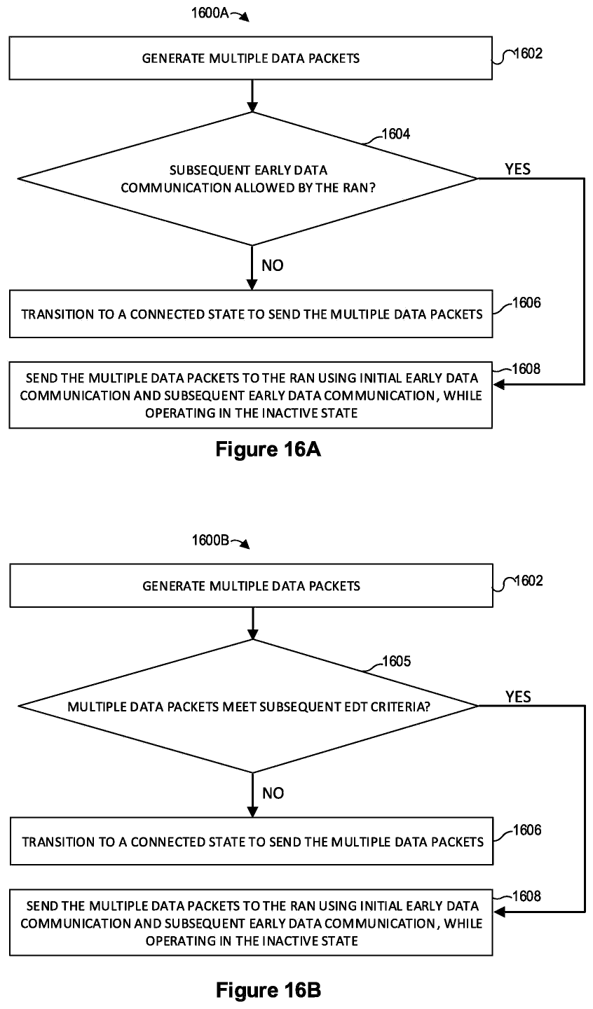

FIG. 16A is a flow diagram of a method 1600A, which can be implemented by a UE (e.g., the UE 102). At block 1602, the UE generates multiple data packets. At block 1604, the UE determines whether subsequent early data communication is allowed by the RAN, similar to block 1504 (e.g., event 418). If not, then the UE transitions to a connected state to send the multiple data packets (e.g., event 445). Otherwise, the UE sends the multiple data packets to the RAN using initial early data communication and subsequent early data communication, while operating in the inactive state (e.g., events 496, 498).

FIG. 16B illustrates a method 1600B, which is similar to the method 1600A. However, after generating multiple data packets at block 1602, the UE determines whether the multiple data packets meet subsequent EDT criteria at block 1605 (e.g., event 419). If the multiple data packets do not meet the subsequent EDT criteria (or if the UE does not have a configuration for performing subsequent EDT), then, at block 1606, the UE transitions to a connected state to send the multiple data packets (e.g., event 445). If the multiple data packets do meet the subsequent EDT criteria, then, at block 1608, the UE sends the multiple data packets to the RAN using initial early data communication and subsequent early data communication (e.g., events 496, 498).

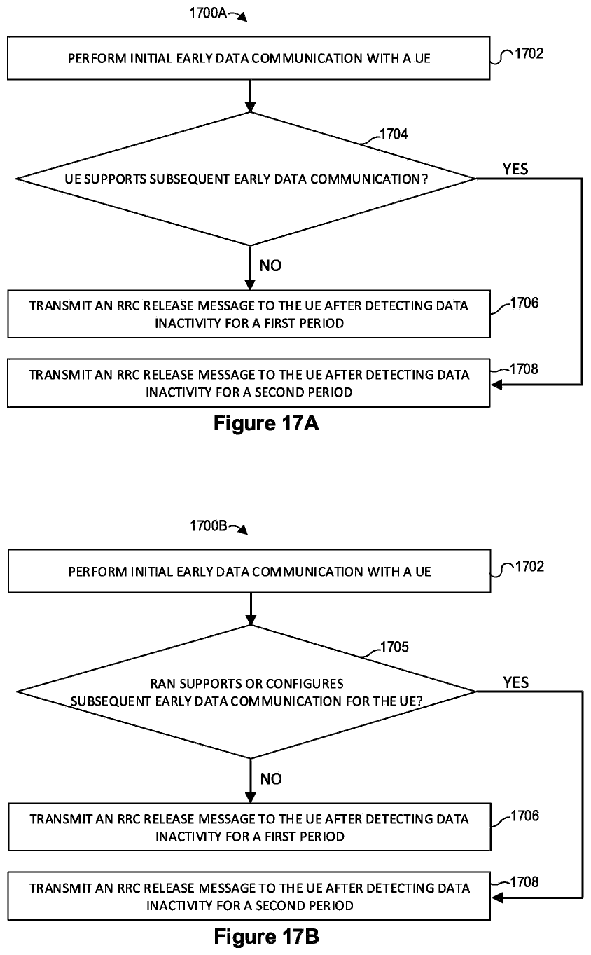

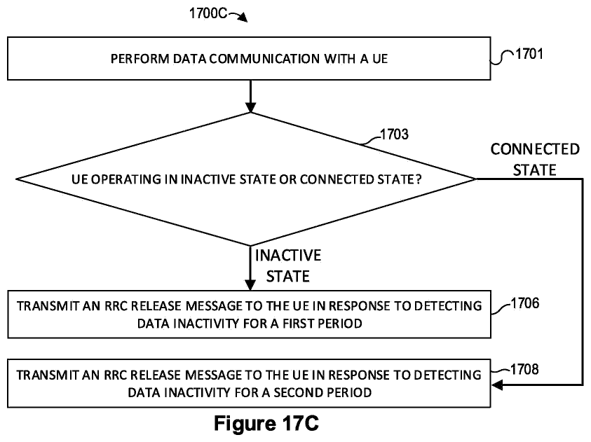

FIGS. 17A-17C flow diagrams of methods 1700A-1700C, respectively, for determining when to send an RRC release message to a UE after performing early data communication, which can be implemented by a RAN (e.g., the RAN 105). Turning first to FIG. 17A, at block 1702, the RAN performs initial early data communication with a UE (e.g., event 396, 496, 596). At block 1704, the RAN determines whether the UE supports subsequent early data communication. If the UE does not support subsequent early data communication, then, at block 1706, the RAN transmits an RRC release message to the UE after detecting data inactivity for a first period. If the UE does support subsequent early data communication, then, at block 1708, the RAN transmits an RRC release message to the UE after detecting data inactivity for a second period. In FIG. 17A, the first period is shorter than the second period. Accordingly, if the UE supports subsequent early data communication, the RAN waits for a longer period of data inactivity to transmit an RRC release message.

FIG. 17B is similar to FIG. 17A. However, instead of block 1704, at block 1705, the RAN determines whether the RAN supports or configures subsequent early data communication for the UE. If not, then the RAN transmits an RRC release message to the UE after detecting data inactivity for a first period, at block 1706. Otherwise, the RAN transmits an RRC release message to the UE after detecting data inactivity for a second period that is a longer than the first period, at block 1708.

Turning to FIG. 17C, at block 1701, the RAN performs data communication with a UE. At block 1703, the RAN determines whether the UE is operating in the inactive state or the connected state. If the UE is operating in the inactive state, then the flow proceeds to block 1706, where the RAN transmits an RRC release message after detecting data inactivity for a first period. If the UE is operating in the connected state, then the flow proceeds to block 1708, where the RAN transmits an RRC release message after detecting data inactivity for a second period that is longer than the first period.

FIGS. 18-21 are flow diagrams of example methods relating to DU capability reporting, which can include capabilities for EDT, or other communication functions.

Turning first to FIG. 18, a method 1800 can be implemented by a DU (e.g., the DU 174). At block 1802, the DU sends, to a CU, a first DU-to-CU message including one or more capabilities of the DU (e.g., events 302, 402, 502). The one or more DU capabilities may include one or more EDT capabilities for one or more EDT functions (e.g., the specific functions discussed with reference to FIG. 10), one or more MBS capabilities for one or more MBS functions, one or more mobility capabilities for one or more mobility functions (e.g., conditional handover, conditional PSCell change or conditional PSCell addition or change and/or dual active protocol stack handover), one or more paging enhancement capabilities for one or more paging enhancement functions (e.g., paging subgrouping and/or paging early detection), and/or one or more other capabilities for one or more other functions (e.g., functions of 3GPP release 17 or later release). In some implementations, the first DU-to-CU message can be a non-UE associated DU-to-CU message. In some implementations, the non-UE associated DU-to-CU message can be a F1 Setup Request message. In other implementations, the non-UE associated DU-to-CU message can be a gNB-DU Configuration Update message. In yet other implementations, the non-UE associated DU-to-CU message can be a DU Capability Information message.

At block 1804, the DU may send, to the CU, a second DU-to-CU message including one or more UE capabilities of a UE (e.g., the UE 102). In some implementations, the second DU-to-CU message can be a UL RRC Message Transfer message. At block 1806, the DU may receive, from the CU, a first CU-to-DU message requesting to enable at least one function for the UE, the at least one function corresponding to at least one of the one or more DU capabilities.

At block 1808, the DU receives, from the CU, a second CU-to-DU message that includes a particular message enabling the at least one function for the UE. In some implementations, the second CU-to-DU message can be a UE Context Release Command message. In other implementations, the second CU-to-DU message can be a DL RRC Message Transfer message. At block 1810, the DU transmits the particular message to the UE. At block 1812, the DU uses the at least one function to communicate with the UE.

In some implementations the DU can send to the CU a third DU-to-CU message including one or more configurations to enable the at least one function for the UE. The CU includes the one or more configurations in the particular message. In one implementation, the DU sends the third DU-to-CU message to the CU in response to the first CU-to-DU message. For example, the first CU-to-DU message and the third DU-to-CU message can be a UE Context Setup Request message and a UE Context Setup Response message, respectively. In another example, the first CU-to-DU message and the third DU-to-CU message can be a UE Context Modification Request message and a UE Context Modification Response message, respectively. In another implementation, the DU sends the third DU-to-CU message to the CU in response to a third CU-to-DU message. For example, the third CU-to-DU message and the third DU-to-CU message can be a UE Context Setup Request message and a UE Context Setup Response message, respectively. In another example, the third CU-to-DU message and the third DU-to-CU message can be a UE Context Modification Request message and a UE Context Modification Response message, respectively. In such examples, the first CU-to-DU message can be a non-UE associated CU-to-DU message (e.g., gNB-CU Configuration Update message or F1 Setup Response message) or a new CU-to-DU message defined in 3GPP specification 38.473.

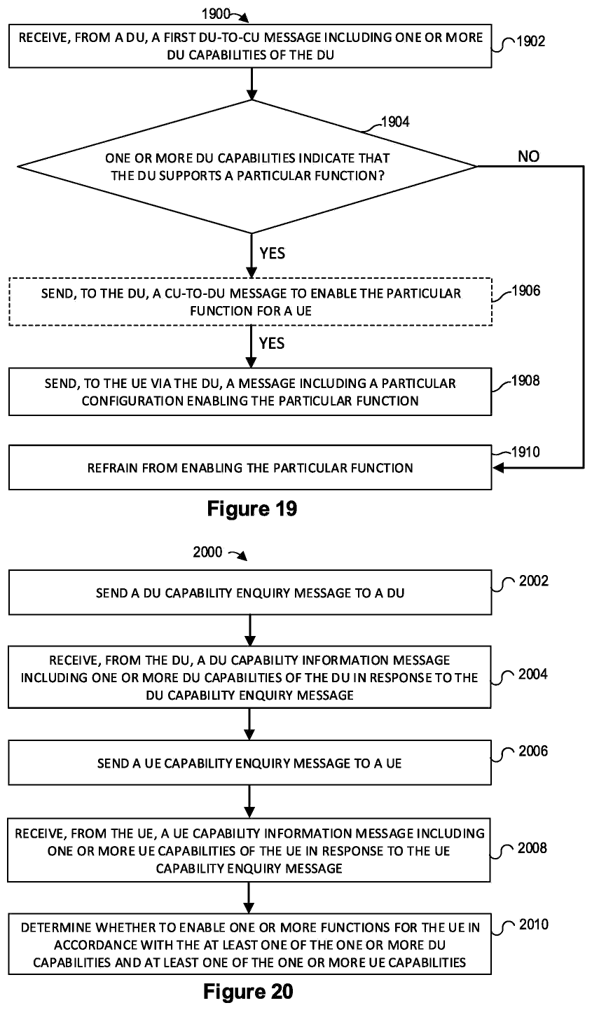

Turning to FIG. 19, a CU (e.g., the CU 172) can implement a method 1900 for enabling a function at a UE based on DU capability information. At block 1902, the CU receives, from a DU, a first DU-to-CU message including one or more DU capabilities of the DU (e.g., events 302, 402, 502). At block 1904, the CU determines whether the one or more DU capabilities indicate that the DU supports a particular function (e.g., any of the functions discussed with reference to block 1802). If so, then the CU may send, to the DU, a CU-to-DU message to enable the particular function for a UE. At block 1908, the CU sends, to the UE via the DU, a message including a particular configuration enabling the particular function. If the DU does not support the particular function, then the CU refrains from enabling the particular function, at block 1910.

Turning to FIG. 20, a CU (e.g., the CU 172) can implement a method 2000 for enabling a function at a UE based on DU capability information and UE capability information. At block 2002, the CU sends a DU Capability Enquiry message to a DU. At block 2004, the CU receives, from the DU, a DU Capability Information message including one or more DU capabilities of the DU, in response to the DU Capability Enquiry message. The CU also, at block 2006, sends a UE Capability Enquiry message to a UE. At block 2008, the CU receives, from the UE, a UE Capability Information message including one or more UE capabilities of the UE in response to the UE Capability Enquiry message. The CU then determines, at block 2010, whether to enable one or more functions for the UE in accordance with the at least one of the one or more DU capabilities and at least one of the one or more UE capabilities. For example, if the DU and the UE both support a function, the CU can enable the function. If either the DU or the UE do not support a function, then the CU can refrain from enabling the function.

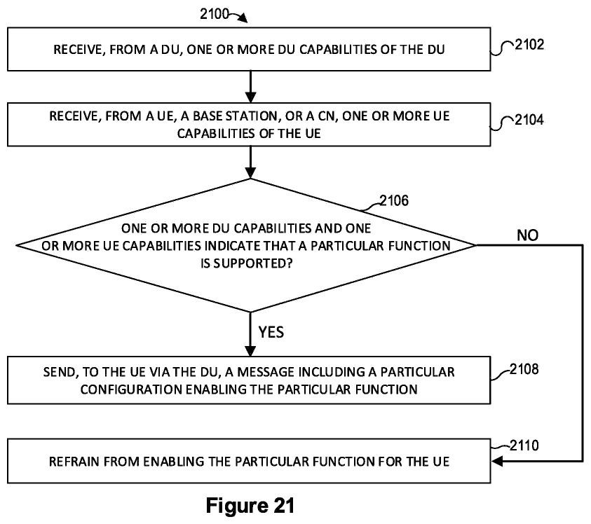

FIG. 21 illustrates a method 2100, which is similar to the method 2000 and can be implemented by a CU. At block 2102, the CU receives, from a DU, one or more DU capabilities of the DU. At block 2104, the CU receives, from a UE, a base station, or a CN, one or more capabilities of the UE. At block 2106, the CU determines whether the one or more DU capabilities and the one or more UE capabilities indicate that a particular function is supported. If so, then the CU can send, to the UE via the DU, a message including a particular configuration enabling the particular function, at block 2108. Otherwise, at block 2110, the CU refrains from enabling the particular function for the UE.

FIG. 22 is a flow diagram of a method 2200 for managing early data communication with a UE (e.g., the UE 102), which can be implemented by a CU (e.g., the CU 172) of a distributed base station (e.g., the base station 104) that includes the CU and a DU (e.g., the DU 174). At block 2202, the CU determines whether a DU supports early data communication (e.g., event 308). The CU may determine whether the DU supports early data communication based on capability information from the DU, which may include an indication of whether the DU supports early data communication (e.g., events 302, 402, 502). At block 2204, the CU determines whether to include a configuration for performing early data communication in a message to the UE based at least in part on whether the DU supports early data communication. At block 2206, the CU transmits the message to the UE via the DU (e.g., events 310 and 312, events 311 and 313). The message may instruct the UE to transition to an inactive state associated with a protocol for controlling radio resources.

In a first instance, for example, the CU includes the configuration in the message in response to determining that the DU supports early data communication. In a second instance, the CU excludes the configuration from the message in response to determining that the DU does not support early data communication.

The CU may also determine whether the DU supports specific EDT-related functions. For example, the CU determines that the DU supports communicating a plurality of data packets with the UE in a single session of the early data communication, and, in response, include in the configuration, a parameter related to communicating the plurality of data packets in the single session (e.g., a subsequent EDT indication). The parameter may indicate a maximum number of data packets that the UE can transmit in the single session, a maximum total data size of the plurality of data packets, and/or a maximum data size of a data packet of the plurality of data packets (e.g., the parameter may be or indicate subsequent EDT criteria). As another example, the CU determines that the DU supports performing early data communication using a configured grant, and includes the configured grant in the configuration. In another example, the CU determines that the DU supports communicating retransmissions or repetitions of a data packet with the UE during early data communication, and includes, in the configuration, a retransmission or repetition configuration enabling the UE to communicate the retransmissions or repetitions. In a further example, the CU determines that the DU supports frequency hopping for early data communication, and includes, in the configuration, a frequency hopping configuration enabling the UE to perform frequency hopping during early data communication. In a yet further example, the CU determines that the DU supports a physical layer acknowledgement for early data communication, and includes a physical layer acknowledgement configuration in the configuration.

In some implementations, the CU receives a request from the UE to initiate early data communication (e.g., event 322) and transmits an indication notifying the DU that the CU is performing early data communication with the UE via the DU (e.g., event 324). The indication may indicate a radio resource control state of the UE.

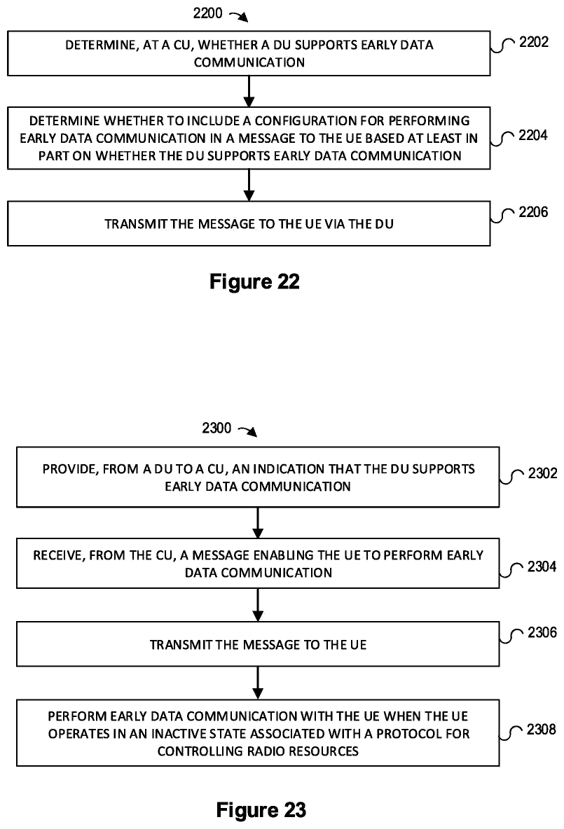

FIG. 23 is a flow diagram of a method 2300 for managing early data communication with a UE (e.g., the UE 102), which can be implemented by a DU (e.g., the DU 174) of a distributed base station (e.g., the base station 104) that includes the DU and a CU (e.g., the CU 172). At block 2302, the DU provides, to the CU, an indication that the DU supports early data communication (e.g., events 302, 402, 502). At block 2304, the DU receives, from the CU, a message enabling the UE to perform early data communication. At block 2306, the DU transmits the message to the UE (e.g., event 310). At block 2308, the DU performs early data communication when the UE operates in an inactive state associated with a protocol for controlling radio resources (e.g., event 396). Depending on the implementation, the DU may also provide an indication of whether the DU supports other functions, including: whether the DU supports communicating a plurality of data packets with the UE during a single session of the early data communication, whether the DU supports performing data communication using a configured grant, whether the DU supports communicating retransmissions or repetitions of a data packet with the UE during early data communication, whether the DU supports frequency hopping for early data communication, and/or whether the DU supports a physical layer acknowledgement for early data communication.

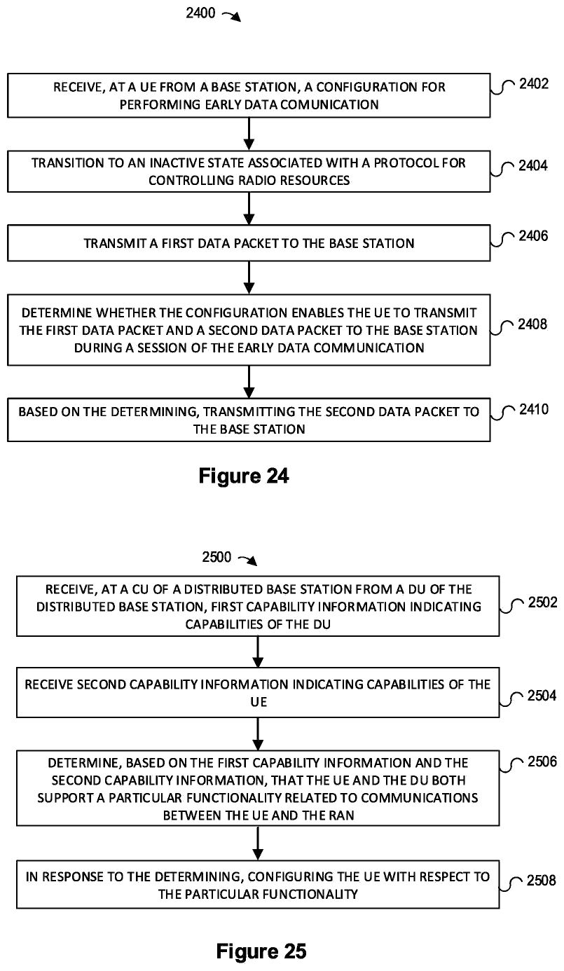

FIG. 24 is a flow diagram of a method 2400 for communicating data with a base station (e.g., the base station 104), which can be implemented by a UE (e.g., the UE 102). At block 2402, the UE receives, from the base station, a configuration for performing early data communication (e.g., events 417, 412). At block 2404, the UE transitions to an inactive state associated with a protocol for controlling radio resources (e.g., RRC_INACTIVE) (e.g., event 414). At block 2406, the UE transmits a first data packet to the base station. At block 2408, the UE determines whether the configuration enables the UE to transmit the first data packet and a second data packet to the base station during a session of the early data communication (i.e., whether the configuration enables the UE to perform subsequent EDT) (e.g., events 418, 419). At block 2410, based on the determining the UE transmits the second data packet to the base station.

In some implementations, transmitting the first data packet includes initiating the session of the early data communication (e.g., initiating an EDT session by performing initial early data communication, as in event 496) and, prior to the determining, transmitting the first data packet to the base station during the session (e.g., as in FIG. 4A). In such implementations, if the UE determines that the configuration enables the UE to transmit the first data packet and the second data packet to the base station during the session, then the UE can transmit the second data packet to the base station during the session (e.g., event 498). If the UE determines that the configuration does not enable the UE to transmit the first data packet and the second data packet to the base station during the session, then the UE may transmit the second data packet to the base station during a second session of the early data communication. Alternatively, the UE can transmit the second data packet by transitioning to a connected state after the session, and transmitting the second data packet to the base station when operating in the connected state (e.g., event 443).

In other implementations, transmitting the first data packet includes transmitting the first data packet to the base station after determining whether the configuration enables the UE to transmit the first data packet and the second data packet to the base station during the session (e.g., as in FIGS. 4B and 4C). In such implementations, if the UE determines that the configuration enables the UE to transmit the first data packet and the second data packet to the base station during the session, then the UE can initiate the session after the determining, and transmit the first and second data packets to the base station during the session. If the UE determines that the configuration does not enable the UE to transmit the first data packet and the second data packet to the base station during the session, then the UE can transition to a connected state and transmit the first and second data packets to the base station while operating in the connected state (e.g., event 445). Alternatively, the UE can remain in the inactive state and transmit the first data packet during a first EDT session and the second data packet during a second EDT session.

The determining at block 2408 may include determining whether the configuration includes a subsequent EDT configuration (e.g., event 418). Additionally or alternatively, the determining at block 2410 may include determining whether the first and second data packets satisfy criteria for subsequent early data communication (e.g., subsequent EDT criteria) included in the configuration (e.g., event 419). The criteria may include a maximum total data size and/or a maximum data packet size.

FIG. 25 is a flow diagram of a method 2500 for managing communications with a UE (e.g., the UE 102), which can be implemented by a CU (e.g., the CU 172) of a distributed base station (e.g., the base station 104) that includes the CU and a DU (e.g., the DU 174). At block 2502, the CU receives, from the DU, first capability information indicating capabilities of the DU. Alternatively, the CU receives the first capability information from a network node (e.g., an OAM node or an AMF). At block 2504, the CU receives second capability information indicating capabilities of the UE (e.g., from the UE, DU, another base station, or CN). At block 2506, the CU determines, based on the first capability information and the second capability information, whether the UE and the DU both support a particular functionality related to communications between the UE and the RAN (e.g., block 2106). The particular functionality may include an early data communication function, MBS functionality, mobility function, or enhanced paging function. At block 2508, based on the determining, the CU configures the UE with respect to the particular functionality (e.g., blocks 2108, 2110).

The following description may be applied to the description above.

The following list of examples reflects a variety of the embodiments explicitly contemplated by the present disclosure:

Example 1. A method in a central unit (CU) of a distributed base station, the distributed base station including the CU and a distributed unit (DU), for managing early data communication with a UE, the method comprising: determining, by processing hardware of the CU, whether the DU supports early data communication; determining, by the processing hardware, whether to include a configuration for performing early data communication in a message to the UE based at least in part on whether the DU supports early data communication; and transmitting the message to the UE via the DU.

Example 2. The method of example 1, further comprising: in a first instance, including the configuration in the message in response to determining that the DU supports early data communication; and in a second instance, excluding the configuration from the message in response to determining that the DU does not support early data communication.

Example 3. The method of example 1, further comprising: determining, by the processing hardware, that the DU supports communicating a plurality of data packets with the UE in a single session of the early data communication; and including, by the processing hardware, in the configuration, a parameter related to communicating the plurality of data packets in the single session.

Example 4. The method of example 3, wherein the parameter indicates a maximum number of data packets that the UE can transmit in the single session.

Example 5. The method of example 3 or 4, wherein the parameter indicates a maximum total data size of the plurality of data packets.

Example 6. The method of any one of examples 3-5, wherein the parameter indicates a maximum data size of a data packet of the plurality of data packets.

Example 7. The method of example 1, wherein: determining that the DU supports early data communication further includes determining whether the DU supports communicating a plurality of data packets with the UE during a single session of the early data communication; and the method further comprising: selecting, by the processing hardware and based on whether the DU supports communicating the plurality of data packets, a time period of data inactivity after which to terminate the single session.

Example 8. The method of any one of the preceding examples, further comprising: determining, by the processing hardware, that the DU supports performing early data communication using a configured grant; and including, by the processing hardware, the configured grant in the configuration.

Example 9. The method of any one of the preceding examples, further comprising: determining, by the processing hardware, that the DU supports communicating retransmissions of a data packet with the UE during early data communication; and including, by the processing hardware, in the configuration, a retransmission configuration enabling the UE to communicate the retransmissions.

Example 10. The method of any one of the preceding examples, further comprising: determining, by the processing hardware, that the DU supports frequency hopping for early data communication; and including, by the processing hardware, in the configuration, a frequency hopping configuration enabling the UE to perform frequency hopping during early data communication.

Example 11. The method of any one of the preceding examples, further comprising: determining, by the processing hardware, that the DU supports a physical layer acknowledgement for early data communication; and including, by the processing hardware, a physical layer acknowledgement configuration in the configuration.

Example 12. The method of any one of the preceding examples, further comprising: receiving, by the processing hardware, a request from the UE to initiate early data communication; and transmitting, by the processing hardware, an indication notifying the DU that the CU is performing early data communication with the UE via the DU.

Example 13. The method of example 12, wherein the indication indicates a radio resource control state of the UE.

Example 14. The method of any one of the preceding examples, wherein determining whether the DU supports early data communication includes: receiving, by the processing hardware from the DU, capability information including an indication of whether the DU supports early data communication.

Example 15. The method of any one of the preceding examples, wherein the message instructs the UE to transition to an inactive state associated with a protocol for controlling radio resources.

Example 16. A method in a distributed unit (DU) of a distributed base station, the distributed base station including the DU and a central unit (CU), for managing early data communication with a UE, the method comprising: providing, by processing hardware of the DU to a CU, an indication that the DU supports early data communication; receiving, by the processing hardware from the CU, a message enabling the UE to perform early data communication; transmitting, by the processing hardware, the message to the UE; and performing, by the processing hardware, early data communication with the UE when the UE operates in an inactive state associated with a protocol for controlling radio resources.

Example 17. The method of example 16, further comprising: providing, by the processing hardware to the CU, an indication of whether the DU supports communicating a plurality of data packets with the UE during a single session of the early data communication.

Example 18. The method of example 16 or 17, further comprising: providing, by the processing hardware, an indication of whether the DU supports performing data communication using a configured grant.

Example 19. The method of any one of examples 16-18, further comprising: providing, by the processing hardware, an indication of whether the DU supports communicating retransmissions of a data packet with the UE during early data communication.

Example 20. The method of any one of examples 16-19, further comprising: providing, by the processing hardware, an indication of whether the DU supports frequency hopping for early data communication.

Example 21. The method of any one of examples 16-20, further comprising: providing, by the processing hardware, an indication of whether the DU supports a physical layer acknowledgement for early data communication.

Example 22. A method in a central unit (CU) of a distributed base station of a radio access network (RAN), the distributed base station including the CU and a distributed unit (DU), for managing communications with a UE, the method comprising: receiving, by processing hardware of the CU from the DU, first capability information indicating capabilities of the DU; receiving, by the processing hardware, second capability information indicating capabilities of the UE; determining, by the processing hardware, based on the first capability information and the second capability information, whether the UE and the DU both support a particular functionality related to communications between the UE and the RAN; and based on the determining, configuring, by the processing hardware, the UE with respect to the particular functionality.

Example 23. The method of example 22, wherein the particular functionality is an early data communication function.

Example 24. The method of example 22, wherein the particular functionality is a multicast broadcast services (MBS) functionality.

Example 25. The method of example 22, wherein the particular functionality is a mobility function.

Example 26. The method of example 22, wherein the particular functionality is an enhanced paging function.

Example 27. A network node of a distributed base station including processing hardware and configured to implement a method according to any one of the preceding examples.

Example 28. A method in a user equipment (UE) for communicating data with a base station, the method comprising: receiving, by processing hardware of the UE from the base station, a configuration for performing early data communication; transitioning, by the processing hardware, to an inactive state associated with a protocol for controlling radio resources; transmitting, by the processing hardware, a first data packet to the base station; determining, by the processing hardware, whether the configuration enables the UE to transmit the first data packet and a second data packet to the base station during a session of the early data communication; and based on the determining, transmitting, by the processing hardware, the second data packet to the base station.

Example 29. The method of example 28, wherein transmitting the first data packet includes: initiating the session of the early data communication; and prior to the determining, transmitting the first data packet to the base station during the session.

Example 30. The method of example 29, wherein: the determining comprises determining that the configuration enables the UE to transmit the first data packet and the second data packet to the base station during the session; and transmitting the second data packet includes transmitting the second data packet to the base station during the session.

Example 31. The method of example 29, wherein: the determining comprises determining that the configuration does not enable the UE to transmit the first data packet and the second data packet to the base station during the session; the session is a first session; and transmitting the second data packet includes transmitting the second data packet to the base station during a second session of the early data communication.

Example 32. The method of example 29, wherein: the determining comprises determining that the configuration does not enable the UE to transmit the first data packet and the second data packet to the base station during the session; and transmitting the second data packet includes: after the session, transitioning to a connected state; and transmitting the second data packet to the base station when operating in the connected state.

Example 33. The method of example 28, wherein transmitting the first data packet includes: transmitting the first data packet to the base station after determining whether the configuration enables the UE to transmit the first data packet and the second data packet to the base station during the session.

Example 34. The method of example 33, wherein: the determining comprises determining that the configuration enables the UE to transmit the first data packet and the second data packet to the base station during the session; the method further comprises initiating the session after the determining; and transmitting the first data packet and transmitting the second data packet comprise transmitting the first data packet and the second data packet during the session.

Example 35. The method of example 33, wherein: the determining comprises determining that the configuration does not enable the UE to transmit the first data packet and the second data packet to the base station during the session; the method further comprises transitioning to a connected state; and transmitting the first data packet and transmitting the second data packet comprise transmitting the first data packet and the second data packet when operating in the connected state.

Example 36. The method of example 33, wherein: the determining includes determining that the configuration does not enable the UE to transmit the first data packet and the second data packet to the base station during the session; the session is a first session; transmitting the first data packet comprises transmitting the first data packet during the first session; and transmitting the second data packet comprises transmitting the second data packet during the second session.

Example 37. The method of any one of examples 28-36, wherein the determining includes: determining whether the configuration includes a subsequent early data communication configuration.

Example 38. The method of any one of examples 28-37, wherein the determining includes: determining whether the first data packet and the second data packet satisfy criteria for subsequent early data communication included in the configuration.

Example 39. The method of example 38, wherein the criteria includes a maximum total data size.

Example 40. The method of example 38, wherein the criteria includes a maximum data packet size.

Example 41. A user equipment (UE) including processing hardware and configured to implement a method according to any one of examples 28-40.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “early data communication” can be replaced by “small data communication” and “early data transmission” can be replaced by “small data transmission”. In some implementations, “communicating data via RB(s)” can be replaced by “communicate data associated to RB(s)” or “communicate data on RB(s)”. “communicate” can be replaced by “transmit”, “receive” or “transmit and receive”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method in a central unit (CU) of a distributed base station, the distributed base station including the CU and a distributed unit (DU), for managing early data communication with a UE, the method comprising:
determining whether the DU supports early data communication;
determining whether to include a configuration for performing early data communication in a message to the UE based at least in part on whether the DU supports early data communication; and
transmitting the message to the UE via the DU.

2. The method of claim 1, further comprising:
in a first instance, including the configuration in the message in response to determining that the DU supports early data communication; and
in a second instance, excluding the configuration from the message in response to determining that the DU does not support early data communication.

3. The method of claim 1, further comprising:
determining that the DU supports communicating a plurality of data packets with the UE in a single session of the early data communication; and
including in the configuration, a parameter related to communicating the plurality of data packets in the single session.

4. The method of claim 3, wherein the parameter indicates at least one of:
a maximum number of data packets that the UE can transmit in the single session, a maximum total data size of the plurality of data packets, or a maximum data size of a data packet of the plurality of data packets.

5. The method of claim 1, wherein:
determining that the DU supports early data communication further includes determining whether the DU supports communicating a plurality of data packets with the UE during a single session of the early data communication; and
the method further comprising:
selecting, based on whether the DU supports communicating the plurality of data packets, a time period of data inactivity after which to terminate the single session.

6. The method of claim 1, further comprising:
determining that the DU supports a specific function, the specific function including at least one: (i) performing early data communication using a configured grant, (ii) communicating retransmissions of a data packet with the UE during early data communication, (iii) frequency hopping, or (iv) a physical layer acknowledgement for early data communication; and
including configuration parameters enabling the specific function in the configuration.

7. The method of claim 1, wherein determining whether the DU supports early data communication includes:
receiving, from the DU, capability information including an indication that the DU supports early data communication, or
receiving, from the DU, capability information including an indication that the DU does not support early data communication.

8. The method of claim 1, wherein the message instructs the UE to transition to an inactive state associated with a protocol for controlling radio resources.

9. A method in a distributed unit (DU) of a distributed base station, the distributed base station including the DU and a central unit (CU), for managing early data communication with a UE, the method comprising:
providing, to a CU, an indication that the DU supports early data communication;
receiving, from the CU, a message enabling the UE to perform early data communication;
transmitting the message to the UE; and
performing early data communication with the UE when the UE operates in an inactive state associated with a protocol for controlling radio resources.

10. The method of claim 9, further comprising:
providing, to the CU, an indication that the DU supports communicating a plurality of data packets with the UE during a single session of the early data communication, or
providing, to the CU, an indication that the DU does not support communicating a plurality of data packets with the UE during a single session of the early data communication.

11. The method of claim 9, further comprising:
providing an indication that the DU supports performing data communication using a configured grant, or
providing an indication that the DU does not support performing data communication using a configured grant.

12. The method of claim 9, further comprising:
providing an indication that the DU supports communicating retransmissions of a data packet with the UE during early data communication, or
providing an indication that the DU does not support communicating retransmissions of a data packet with the UE during early data communication.

13. The method of claim 9, further comprising:
providing an indication that the DU supports frequency hopping for early data communication, or
providing an indication that the DU does not support frequency hopping for early data communication.

14. The method of claim 9, further comprising:
providing an indication that the DU supports a physical layer acknowledgement for early data communication, or
providing an indication that the DU does not support a physical layer acknowledgement for early data communication.

15. A central unit (CU) of a distributed base station that includes a distributed unit (DU), the CU including processing hardware and configured to:
determine whether the DU supports early data communication;
determine whether to include a configuration for performing early data communication in a message to the UE based at least in part on whether the DU supports early data communication; and
transmit the message to the UE via the DU.

16. The CU of claim 15, further configured to:
in a first instance, include the configuration in the message in response to determining that the DU supports early data communication; and
in a second instance, exclude the configuration from the message in response to determining that the DU does not support early data communication.

17. The CU of claim 15, further configured to:
determine the DU supports communicating a plurality of data packets with the UE in a single session of the early data communication; and
include, in the configuration, a parameter related to communicating the plurality of data packets in the single session.

18. The CU of claim 17, wherein the parameter indicates at least one of: a maximum number of data packets that the UE can transmit in the single session, a maximum total data size of the plurality of data packets, or a maximum data size of a data packet of the plurality of data packets.

19. The CU of claim 15, wherein:
to determine that the DU supports early data communication, the CU is configured to determine whether the DU supports communicating a plurality of data packets with the UE during a single session of the early data communication; and
CU further configured to:
select, based on whether the DU supports communicating the plurality of data packets, a time period of data inactivity after which to terminate the single session.

20. The CU of claim 15, further configured to:
determine that the DU supports a specific function, the specific function including at least one: (i) performing early data communication using a configured grant, (ii) communicating retransmissions of a data packet with the UE during early data communication, (iii) frequency hopping, or (iv) a physical layer acknowledgement for early data communication; and
include configuration parameters enabling the specific function in the configuration.
